(19) United States
(12) Patent Application Publication
(10) Pub. No.: US 2012/0019393 A1
(43) Pub. Date: Jan. 26, 2012

(54) SYSTEM AND METHOD FOR TRACKING CARTS IN A RETAIL ENVIRONMENT

(76) Inventors: Robert Wolinsky, Fairfield, CT (US); Richard Lefkowitz, Suffern, NY (US); Robert Thompson, Parsippany, NJ (US); John Freeman, East Orange, NJ (US); Thomas Wendowski, Fairfield, NJ (US); Peter Goldring, Edgewater, NJ (US); Mikhail Marsky, Ramsey, NJ (US); Peter Daly, Yorktown Heights, NY (US); Dominick Salvato, Salem, NY (US); Todd Swanzey, Putnam Valley, NY (US); Joseph Cabana, Centereach, NY (US)

(21) Appl. No.: 13/052,946

(22) Filed: Mar. 21, 2011

Related U.S. Application Data
(63) Continuation-in-part of application No. 12/848,852, filed on Aug. 2, 2010.
(60) Provisional application No. 61/230,338, filed on Jul. 31, 2009.
(60) Provisional application No. 61/315,751, filed on Mar. 19, 2010.

(51) Int. Cl. G08B 21/00

(52) U.S. Cl. 340/686.1

(57) ABSTRACT

A system and method for tracking a shopping cart in a retail store may include communicating signals into the pathways from multiple locations, where the signals may include identifiers indicative of location of respective signals. The communicated signals with the identifiers may be received, and the identifiers may be recorded. The recorded data may be processed to determine a path taken by the shopping cart through the retail store. The path of the shopping cart taken through the retail store may be presented to a user.

### RELATED APPLICATIONS

This Application for Letters Patent is a Continuation-in-Part of co-pending U.S. patent application Ser. No. 12/848,852 filed Aug. 2, 2010, which claims priority to U.S. Provisional Application Ser. No. 61/230,338 filed Jul. 31, 2009, and further claims priority to co-pending U.S. Provisional Patent Application 61/315,751 filed Mar. 19, 2010; the entire contents of which are herein incorporated by reference in their entirety.

### BACKGROUND

Since the beginning of home television, audience delivery and viewership demographics have been the primary measure by which television networks have set advertising rates and by which advertisers have been willing to pay for airtime on television. The business of television is truly a numbers game—the more eyeballs watching, the more advertisers pay.

In the case of Nielsen measurement of in-home television program viewing, it is understood that gross viewership or tracking data is tallied via sampling and tracking methodologies in approximately 5,000 U.S. households, which is known as a sample set. The sample is therefore considered mathematically representative of total U.S. programming viewership in approximately 111 million television households. The tracking data collected establishes actual programming watched at various timeslots within a particular hour and day by the sample set. The actual tracking data is then scaled-up to represent total potential U.S. household viewership for each program being monitored. Ratings, generally quotients, are then applied that permit comparative assessments between programming viewing and audience delivery within a given market. Advertisers and advertising agencies have accepted these ratings as being the standard by which advertising rates are set.

In the case of in-home television, it is generally understood that programming is used to acquire an audience for the purpose of showing advertisements to viewers, and that programming desirability generates disparate audience aggregation tallies The programming may be in the form of situation comedies (“sit coms”), sporting events, reality television shows, movies, news, educational programming, and so on.

In the case of retail establishments, however, rather than having programming as in the case of in-home television to aggregate an audience, the actual goods being sold within the retail stores are the equivalent to programming that are used to draw shoppers or viewers to aggregate the shopping audiences. It is recognized that other factors, such as service, cleanliness, location, and so on, may also factor into attracting customers, but the primary draw for the shopping audience tends to be the goods being sold. In the case of out-of-home television located in retail establishments, gross audience tallies vary little as the programming (i.e., goods being sold) is consistent day-to-day, week-to-week.

For the purposes of establishing audience viewership or reach for out-of-home television located in retail establishments, historically, audience reach has been derived via cash register transaction data or tallies of purchases, whereby each transaction may represent a potential viewer. However, transaction data only accounts for the number of individuals that enter the store and actually purchase goods. Additional sampling may be used to establish how many individuals may have accompanied the shopper. The derived data (i.e., transaction data and additional sampling) from such tallies is methodologically flawed for media purposes, however, because such measurement does not establish any actual television viewing or audience reach and, as such cannot represent actual audience delivery (as described in co-pending U.S. patent application Ser. No. 12/368,232 filed on Feb. 9, 2009, which is herein incorporated by reference in its entirety), in the course of a shopper traveling through aisles or those viewers that may enter the store but not purchase any goods.

Another mathematically flawed historical methodology that has been historically used is to position a few electronic displays around the outside “raceway” aisles of the retail store as it was thought that a majority of shoppers traveled in these aisles or at locations where shoppers may dwell (e.g., deli-counters or fruits and vegetable areas). Such positioning of the electronic displays has been performed primarily to save costs as it is expensive to install electronic displays in retail stores. However, placing only a few electronic displays in the outside “raceway” aisles or dwell locations has never been accepted by advertisers or media agencies as providing quantifiable basis whereby media metrics (e.g., audience reach and frequency of view of advertisements, audience reach, and audience delivery) are believed (for shopper-based audiences) to be the same or analogous as those provided by in-home television. Consequently, as a result of the historically flawed audience measurement methodologies, no quantitative assessment can be made regarding the actual number of viewers, or audience size or reach, in out-of-home television systems located in the retail establishment. Such assessment has been shown to be true by the fact that no advertising agencies or advertisers have considered out-of-home television in retail stores to provide media metrics that are the same, analogous, or backwardly compatible to in-home media metrics.

Tracking systems of shoppers within retail stores have a variety of implementations. The primary technique for tracking shoppers includes tracking shopping carts by securing a radio frequency (RF) transmitter to the shopping cart and position RF receivers throughout the store to receive RF signals from the RF transmitter. Triangulation and signal strength is typically used to specifically identify location of the RF transmitter secured to the cart as it traverses throughout the store. RF transmission and triangulation are two technically difficult technologies to contend with when operating within a retail environment for a variety of reasons. RF transmission is generally problematic when utilized in closed spaces and metallic structures exist, generally a configuration of retail stores. As understood in the art, RF transmission can have reflections, phase variations, and other RF effects that cause receiving an RF signal to be difficult to accurately determine distance from the transmitter. RF communications equipment can also be expensive to construct and install in a retail store. Furthermore, calibration is needed for RF asset tracking systems, whereby prior to use of the tracking system, someone has to walk the transmitter around the store and calibrate measurements as the transmitter is moved throughout the store. Because of installation and calibration time and cost, most companies that build and operate asset tracking systems for such retail applications, few, if any, are ever sold due to being cost prohibitive as the cost for such installed systems can typically run into the hundreds of thousands of dollars.

### SUMMARY

To overcome the historically flawed methodologies in measuring out-of-home television media metrics in retail environments, the principles of the present invention provide for tracking customer traffic by tracking shopping carts or individual shoppers, collectively shopping carts or shoppers, that are traversing through a retail environment so that electronic displays of an electronic display network (out-of-home television network) can be positioned to capture an audience that meets certain media metrics (e.g., audience reach or viewership, frequency of view of airtime segments). By tracking the shopping carts through the retail environment and determining which zones are passed through by percentage of total customers that shop in the retail environment, a specific number of electronic displays can be determined and positioned in locations that satisfy an audience reach criteria (e.g., 95% of shoppers), thereby limiting the total number of electronic displays that are deployed in the retail environment while providing for media metrics that are the same or substantially similar and, therefore, backwardly compatible to in-home media metrics.

The audience reach and delivery metrics can be used (i) to assure out-of-home television platform or system users, which may be advertisers and media agencies, an actual tally of viewers, or audience delivery, and (ii) to assure that all or a certain percentage of customers or traffic have seen a particular advertisement at least one time in the course of a shopping trip. Such audience reach and delivery metrics data, which are now quantifiable, may be organized in a form consistent with typical Nielsen data and assessments utilized in its in-home television viewership sampling system, as known in the art. As a result, viewership ratings that are comparable to in-home television ratings (e.g., Nielsen ratings) may be generated based on quantifiable audience viewership in the retail environment.

One embodiment of a system for tracking a shopping cart in a retail store may include a plurality of transmitter devices positioned along pathways within the retail store, and configured to communicate respective signals into the pathways. The signals may include identifiers that identify respective transmitter devices from which the signals are being communicated. A receiver device may be connected to a shopping cart, and configured to receive and record the identifiers communicated in the signals. A computing system may be configured to receive the recorded identifiers from the receiver device, process the recorded identifiers to determine a path taken by the shopping cart through the retail store, and present the path of the shopping cart taken through the retail store to a user. In one embodiment, the presentation includes time for the shopping cart to traverse through the retail store. In an alternative embodiment, the presentation of the path of the shopping cart may be included with path data of other shopping carts.

One embodiment of a method for tracking a shopping cart in a retail store may include communicating signals into the pathways from multiple locations, where the signals may include identifiers indicative of location of respective signals. The communicated signals with the identifiers may be received, and the identifiers may be recorded. The recorded identifiers may be processed to determine a path taken by the shopping cart through the retail store. The path of the shopping cart taken through the retail store may be presented to a user. In one embodiment, the presentation includes time for the shopping cart to traverse through the retail store. In an alternative embodiment, the presentation of the path of the shopping cart may be included with path data of other shopping carts.

One embodiment of a method for determining placement of an electronic device in a retail store may include scanning an indicia on the electronic device being installed in a retail store and an indicia at a location in the retail store at which the transmitter is being installed. The transmitter and location information represented by the indicia may be collected. Data based on location data of the transmitter may be generated, and a report of the data may be provided to a user. The electronic device may be a transmitter device, such as an IR transmitter. The indicia on the electronic device may be a barcode, and the indicia at the location of the transmitter being installed may be a UPC barcode on a product at the location. The generated data may include shopping cart tracking data. The reporting of the data may include statistics of the shopping cart tracking data.

### BRIEF DESCRIPTION OF THE DRAWINGS

A more complete understanding of the method and apparatus of the principles of the present invention may be obtained by reference to the following Detailed Description when taken in conjunction with the accompanying Drawings herein:

FIG. 1 is an illustration of an illustrative network aisle shown to include gondolas that are used to display products that are available for purchase by customers or shoppers;

FIG. 2 is an illustration of an illustrative retail store floor plan;

FIG. 3 is a floor plan of an illustrative retail store that includes a shopping cart tracking system for tracking carts that travel throughout the retail store;

FIG. 4 is a floor plan of an illustrative retail store that includes a shopping cart tracking system that uses IR signals;

FIG. 5 is an illustrative shopping cart tracking system;

FIG. 6 is an illustration of an illustrative network environment shown to include a network service provider server that is in communication with shopping cart tracking systems via communications network;

FIG. 7 is a chart of illustrative shopping cart position data indicative of which particular zones the shopper of FIG. 2 traveled;

FIG. 8 is a chart of illustrative shopping cart velocity data representative of the velocities that the shopper of FIG. 2 traveled through the zones identified in FIG. 7 and listed in TABLE I;

FIGS. 9, 10, and 11 are graphs of illustrative shopper metrics;

FIG. 12 is an illustrative process for determining positioning of electronic displays in an electronic display network;

FIG. 13 is a flow diagram of an illustrative process for determining or recertifying audience metrics of an in-store television network;

FIG. 14 is a floor plan representation of the illustrative retail store of FIG. 4;

FIG. 15 is a screen shot of an illustrative graphical user interface (GUI) that allows a user to generate a report of shopper data;

FIGS. 16A-16E are illustrations of illustrative transmitter devices that are configured to transmit optical signals to enable receiver devices on shopping carts to receive transmitted data for tracking purposes;

FIG. 17 is a signal diagram of an illustrative data signal communicated by an IR tag;

FIG. 18 is a signal diagram of an illustrative pulse train using the communications protocol of FIG. 17;

FIG. 19 is an illustration of an illustrative IR tag or IR transmitter for use within a retail store is provided;

FIG. 20 is an illustration of an illustrative IR tag or IR transmitter, which may include structural components for temporarily mounting the IR tag within a retail store;

FIG. 21 is an illustrative IR transmitter/shelf configuration that includes a metallic shelf with an IR tag or transmitter mounted below the metallic shelf;

FIG. 22 is a block diagram of an illustrative IR receiver that may receive signals from IR tags throughout a retail store;

FIG. 23 is an illustration of an exploded view of an illustrative IR receiver that is mounted to a front grill of a cart;

FIG. 24 is a flow diagram of an illustrative process for an IR tag to perform cart tracking communications;

FIG. 25 is a flow diagram of an illustrative process for an IR receiver to operate;

FIG. 26 is a flow diagram of an illustrative process for tracking shopping carts in accordance with the principles of the present invention; and

FIG. 27 is a flow diagram of a process for enabling a person to install an IR transmitter and for enabling a computing device to track the location of the IR transmitter.

### DETAILED DESCRIPTION OF THE INVENTION

In order to provide for efficiency in terms of total number of electronic displays and positioning of the electronics displays that are used to form an out-of-home television network in a retail environment, the principles of the present invention provide for measuring customer traffic flow in a retail store by tracking shopping carts and/or baskets or individual shoppers as they traverse around the retail store. Zones may be established that allow a network service provider to determine through what zones customers most often travel. Customer flow and viewing metrics may be generated and used to determine locations that the electronic displays are to be positioned to capture a certain audience percentage or reach. While identifying zones of heaviest traffic allows for minimization of the number of electronic displays used to reach an audience (i.e., customers) above a desired percentage (e.g., 95% of all customers that enter the retail store), the placement of the electronic displays also provide for other media metrics, such as frequency of view by the audience and actual audience delivery totals, and as described in co-pending U.S. patent application Ser. No. 12/368,232. In addition, the media metrics determined through use of the principles of the present invention may result in the same or similar, and, therefore, backwardly compatible media metrics as traditional in-home television so that the out-of-home television audience media metrics (e.g., audience size and frequency of play) can be aggregated or compared with in-home television media metrics, thereby harmonizing the measurement scheme between each platform. Additionally, the measurement scheme establishes a unified measure system across varying retail systems that, when coupled with media metrics (i.e., audience size and frequency of play), provides a mathematically sound extrapolative environment for audience measurement (i.e., audience delivery) from out-of-home television in a retail environment.

Cart tracking can be used for measuring retail customer traffic flows across disparate retail environments in order to establish a scientific method whereby retail customer traffic flows can be measured in accordance with standard media metrics for planning and buying an audience. These audience delivery metrics can be used (i) to assure out-of-home television platform or system users, which may be advertisers and agencies, an actual tally of viewers, (ii) to assure that all or a certain percentage of customers or traffic has seen a particular advertisement at least one time in the course of a shopping trip, and (iii) to create a basis for media ratings and comparable assessments. Such audience delivery metrics data may be organized in a form consistent with typical Nielsen data and assessments utilized in its in-home television viewer sampling system, as known in the art.

In order to resolve the audience measurement problem, the principles of the present invention provide for a system and method using a cart tracking system with low-cost construction and installation with respect to RF asset tracking systems to measure total customer traffic flows, regardless of transaction data, in various geographical locations within the retail store. The measured customer traffic flows may be utilized to determine specific placement of television screens or electronic displays to establish (i) substantially 100% audience delivery and frequency of viewing, as described in co-pending U.S. patent application Ser. No. 12/368,232, which is incorporated herein in its entirety, to shoppers or viewers, and (ii) metrics that utilize sample data to facilitate the process of determining audience delivery and frequency of view in similar fashion to traditional in-home television so that the out-of-home television audience delivery can be aggregated with those audiences counted within in-home television, thereby harmonizing the measurement scheme between each platform. Additionally, the measurement scheme establishes a unified measure system across varying retail systems that when coupled with media metrics (e.g., audience delivery and frequency), provides a mathematically sound extrapolative environment for audience measurement (e.g., audience delivery) in out-of-home television.

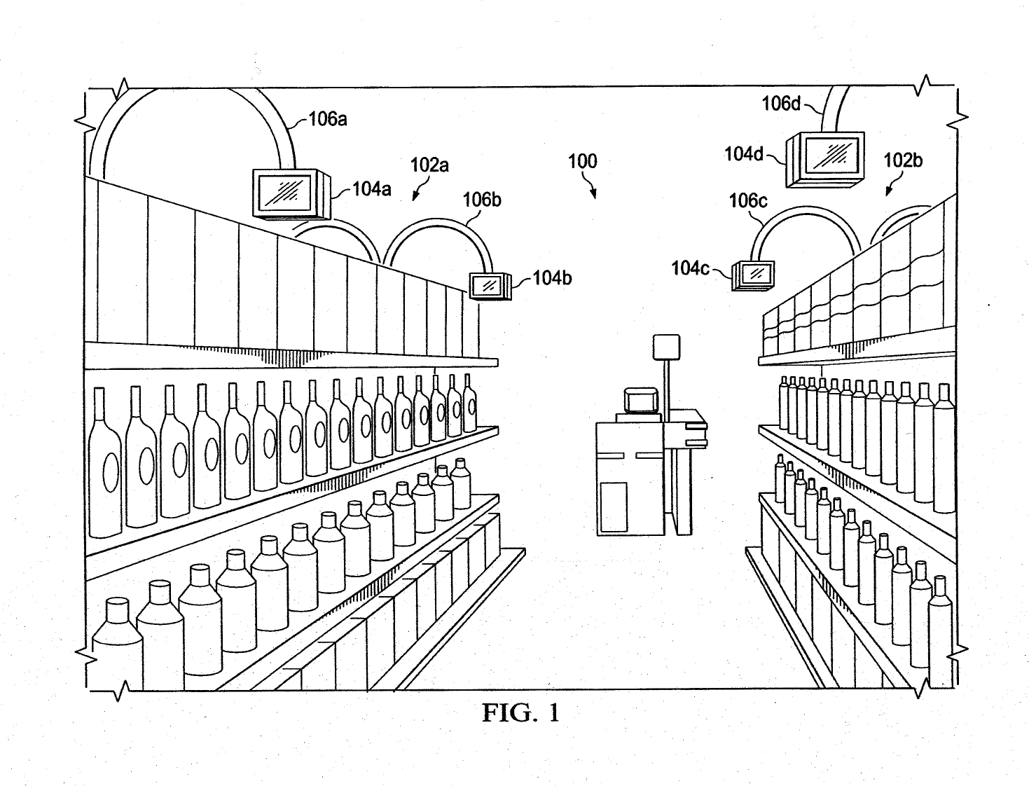

With regard to FIG. 1, an illustration of an illustrative network aisle 100 is shown to include two gondola runs 102a and 102b (collectively 102), shown on the left and right, that are used to display products that are available for purchase by customers or shoppers. The terms “customers” and “shoppers” are used interchangeably herein. The gondolas may be configured with a power bus (not shown), as described in co-pending U.S. Provisional Patent Application 61/332,503 filed on May 7, 2010, which allows for electronic displays 104a-104d (collectively 104) to be powered and be positioned in a wide range of locations along the gondolas 102. The electronic displays 104 may be paired (i.e., one electronic display faces one direction and the other electronic display faces the other direction) on each of the extension arms 106. Extension arms 106a-106d (collectively 106) may couple the electronic displays 104 to the power bus, where power and, optionally, data may be delivered to the electronic displays 104 via electrical conductors (not shown) extending through the extension arms 106.

Customers have the ability to view the electronic displays from a certain distance and adequately see an image that is being displayed on the image. The distance that a viewer can adequately can view an image on an electronic display may be based on a number of electronic display parameters, including size, contrast, sharpness, resolution, content, and so on, as understood in the art. Of course, for longer distance viewing, content displayed has to be appropriate (e.g., font size should be large). By way of example, a thirteen-inch electronic display (measured along the diagonal) with suitable image parameters may be viewed at a distance between 60 and 70 feet and allow the viewer to determine the content being displayed on the electronic display. By using distance principles in combination with audience measurements, the principles of the present invention may reduce the number of electronic displays used with a retail store and still provide for media metrics (e.g., audience reach and frequency of view). In one embodiment, a distance D between electronic displays 104a and 104b may be used between electronic displays in aisle 100 so that shoppers that are traversing along the aisle 100 have the opportunity and ability to view each airtime segment being displayed on the electronic displays 106 throughout the entire length of the aisle 100.

As a summary of the operation of the electronic displays 106 that collectively form an out-of-home television network in a retail store, the electronic displays 106 may be configured to display airtime segments substantially simultaneously with one another. Advertisements and other content displayed on the electronic displays 106 may be looped. The loop is commonly known as a “wheel.” If the average shopping trip in the retail store is a multiple of the “wheel” length, then each average shopper in the retail store has the opportunity to view each airtime segment in the “wheel” that multiple number of times. For example, if the average shopping trip in the retail store is 30 minutes and the “wheel” length is 10 minutes, then each average shopper (i.e., a shopper who shops for 30 minutes) has the ability to view each airtime segment three times. If each airtime segment is 10 seconds long, then there are six airtime segments per minute and 60 every 10 minutes. Thus, the average shopper has the opportunity to view each of the 60 airtime segments three times. In the media business, if one percent of all households in a designated market area (DMA), as defined by Nielsen, have viewed an advertisement one time, that is calculated as a one rating point in a given market. If a household, or particular demographic of viewers as assessed by the media agency, views the advertisement three times, that is considered a gross rating point. By using a wheel length that is approximately one-third the average shopping trip in the retail store, both rating points and gross rating points may be delivered by the out-of-home television or electronic display network in retail stores, which collectively makes the in-store media metrics backwardly compatible with in-home television for assessing reach to a particular audience and frequency of view as is known in the art.

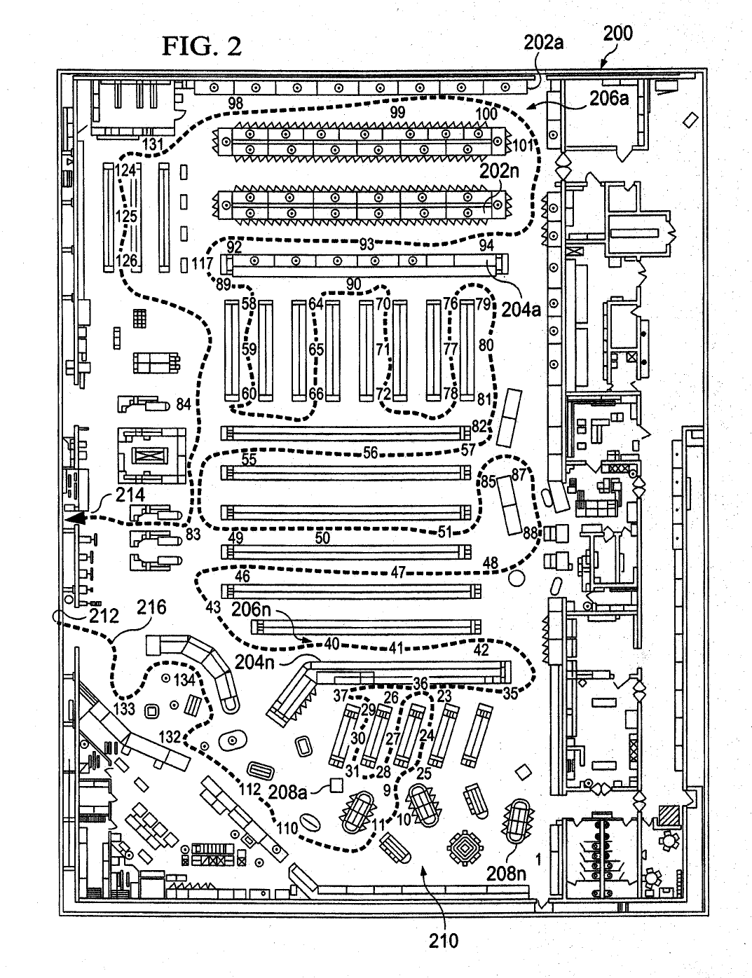

With regard to FIG. 2, an illustration of an illustrative retail store floor plan 200 is shown. The floor plan 200, which may be that of a grocery store, is shown to include refrigerators 202a-202n (collectively 202), gondola runs 204a-204n (collectively 204), aisles 206a-206n (collectively 206) extending between the gondola runs 204, product displays 208a-208n (collectively 208), and wander area 210 within which the product displays 208 reside. It should be understood that alternative configurations of the retail store floor plan 200 may be utilized in accordance with the principles of the present invention. It should also be understood that other types of retail stores may be populated with an electronic display network that forms out-of-home television, as described herein.

Shoppers enter the retail store via entryway 212 and exit the retail store via an exit way 214. An illustrative shopper pathway 216 that a shopper takes as he or she shops in the retail store is shown. The shopper pathway 216 is shown to traverse through the wander area 210 and aisles 206. To track shopper pathways that each shopper at the retail store travels, a shopping cart tracking system, which may track shopping carts and/or baskets, may be employed. The aisles 206, wander area 210, and other pathway areas may be partitioned into zones 1-134 (note that zones 1-134 are aligned with sensors 1-134 and are used interchangeably). As the shopping carts traverse through each of the zones, the shopping cart tracking system is configured to determine which of the zones the shopping carts travel. Timestamps may be used to provide for determining length of time the shopping carts are in the respective zones and speed at which the shoppers travel through the respective zones.

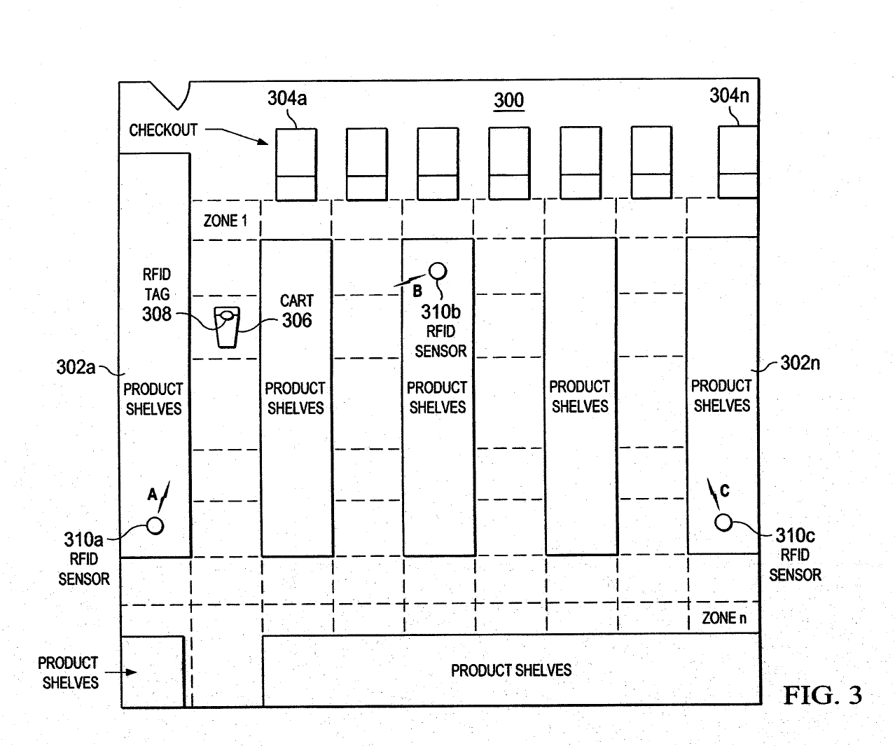

With regard to FIG. 3, a floor plan of an illustrative retail store 300 that includes a shopping cart tracking system for tracking carts that travel throughout the retail store. The floor plan 300 shows product shelves or gondola runs 302a-302n (collectively 302) that are configured to support and display products available for purchase in the retail store. Checkout counters 304a-304n (collectively 304) are available for shoppers to purchase products that the customers select from the product shelves 302.

In this embodiment, the shopping cart tracking system operates using RF signals for tracking shopping carts, such as shopping cart 306. As shown, the shopping cart 306 has an RFID tag 308 mounted thereto so that the shopping cart may be tracked as it traverses around the retail store. To track the shopping cart 306, three RFID sensors 310a-310c (collectively 310), which may be RF transponders, may be configured to communicate with the RFID tag 308 by communicating RF signals A, B, and C. RFID tag 308 may be an active RFID tag and be responsive to the RF signals A, B, and C to communicate a response signal (not shown) back to the RFID sensors 310a. The RF signals A, B, and C may be 802.11 Wi-Fi® signals. Alternatively, the RFID tag 308 may be an active RFID tag and generate a beacon signal (not shown) that each of the RFID sensors 310 receive. Still yet, the RFID tag may be a passive RFID tag and respond with an RF signal in response to being excited by the RF signals A, B, and C. Alternative RF signaling may be utilized in accordance with the principles of the present invention. A computer system (not shown) may be configured to process signals received by the RFID sensors 310 to perform a triangulation measurement to determine specific location of the shopping cart 306. As is understood in the art, RF triangulation measurements may be precise, but complex, especially with closed environments with metal shelving as is typical in retail stores. It is also understood the IR sensors may be positioned on the shelves and an IR tag/transmitter may be positioned on the cart.

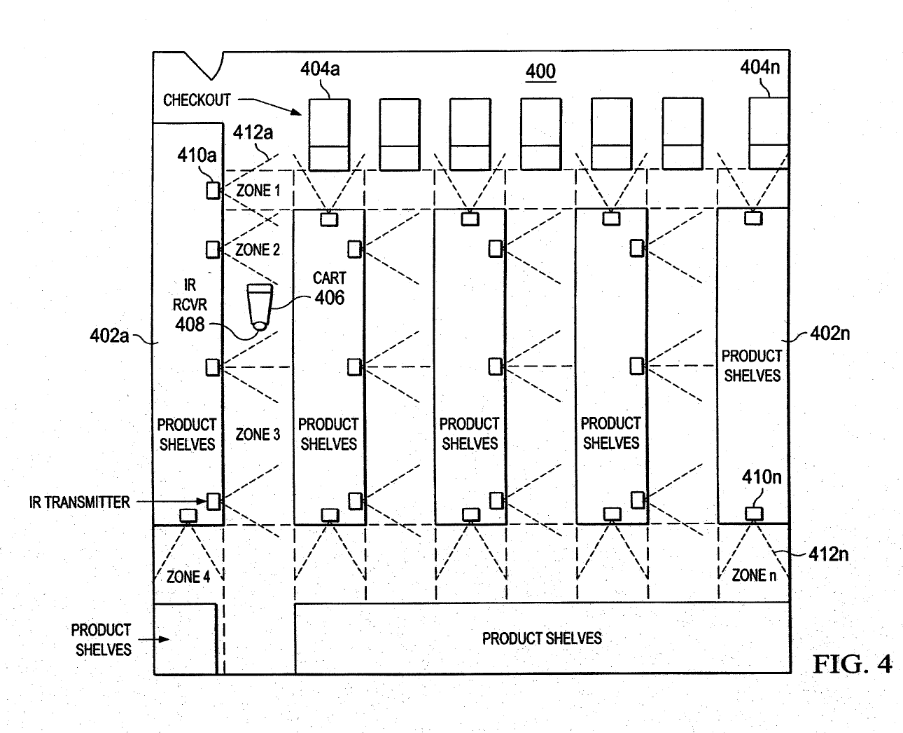

With regard to FIG. 4, a floor plan of an illustrative retail store 400 is shown. The retail store 400 has the same configuration as retail store 300 (FIG. 3), as gondola runs 402a-402n (collectively 402) and checkout counters 404a-404n (collectively 404) are positioned in the same locations as retail shelves 302 and checkout counters 304, respectively. In this embodiment, however, rather than using a shopping cart tracking system that uses RF signals, infrared (IR) signals, which are optical signals, are used. Optical wavelengths other than IR may alternatively be utilized. Further in this embodiment, cart 406 has an IR receiver 408 mounted on the front of the cart 406 so that products that are loaded into the cart 406 do not block the optical vision of the IR receiver 408. The IR receiver 408 may alternatively be mounted to another location of the shopping cart. IR transmitters or tags 410a-410n (collectively 410) may be configured to generate IR signals 412a-412n (collectively 412). In this configuration, the IR receiver 408 receives the IR signals 412 communicated by respective IR tags 410. The IR signals 412 may include unique identification codes associated with respective IR tags 410 within the retail store so that the IR receiver 408 may track (i) which of the IR tags 410 are passed, (ii) in what order the IR tags 410 are passed, (iii) time that the IR tags 410 are passed, and, optionally, (iv) in what direction the IR tags 410 are passed. The IR tags 410 may be inexpensive and the resulting cart tracking system may be much less expensive than that of the cart tracking system as provided in FIG. 3. The cart tracking system of FIG. 4 is further described in co-pending U.S. Provisional Patent Application 61/315,751. It is also understood that another embodiment not shown could have an RF sensor positioned on the cart with RF tags positioned on the gondolas.

Whether a cart tracking system using RF signals and triangulation (FIG. 3) or IR signals (FIG. 4) is used, the principles of the present invention provide for establishing zones 1-n in the pathways of the retail stores 300 and 400. The zones may be related to product categories or unrelated to product categories. The zones may be regularly spaced or non-regularly spaced. In one embodiment, the zones may be defined by a grid (not shown) that is used for a planogram within the retail store that has rows and columns with regular spacings. Alternatively, the zones may be configured to be consistent with distances that electronic displays may be viewed, as described above. Customers who travel in the retail store may be tracked via the shopping carts or baskets, if so equipped, so that traffic patterns may be determined. In addition to traffic patterns being determined, shopping trip times and average shopping trip times may be determined. These shopping trip times may be determined over different days of the week and different times of the day. Still yet, because the shopping cart tracking systems provide for detailed traffic patterns and may include timestamps with each position measurement, time within each zone and speed within each zone may be computed so that the network service provider can determine (i) percentage of total shoppers that travel through which zones and directions of travel to determine where to position electronic displays so that a minimal number may be used to provide for desired media metrics, and (ii) media metrics on a zone-by-zone basis, including number of airtime segments that an average shopper (e.g., a shopper that travels an average speed in a particular zone) has an opportunity to view within each zone. Other shopper and media metrics data may be determined in accordance with the principles of the present invention.

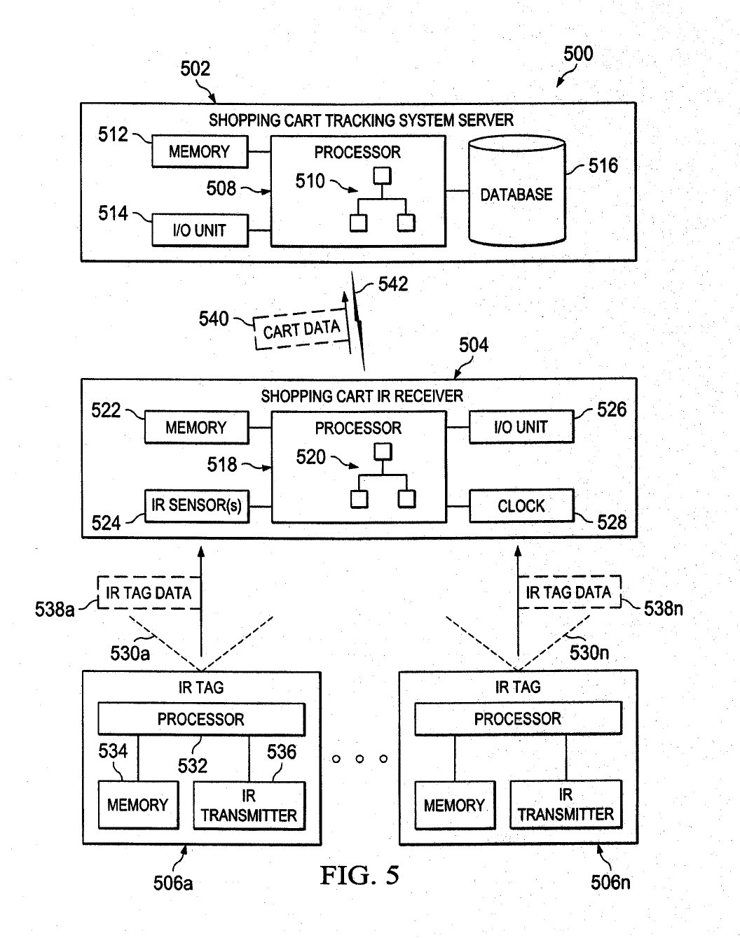

With regard to FIG. 5, an illustrative shopping cart tracking system 500 is shown. The shopping cart tracking system 500 may include a shopping cart tracking system server 502 and shopping cart IR receiver 504, if using the IR system of FIG. 4. If, alternatively, the RF system of FIG. 3 is used, then a shopping cart RFID tag would be used instead of the shopping cart IR receiver 504. It should be understood that each or a subset of the shopping carts of the retail store may be configured with a shopping cart IR receiver. If IR receivers are to be used with shopping baskets, the same or alternative electrical and/or mechanical configuration may be utilized in accordance with the principles of the present invention. IR tags 506a-506n (collectively 506) may be positioned around a retail store (e.g., below shelves) so as to define zones (e.g., start/end of zones, center of zones).

The shopping cart tracking system server 502 may include a processing unit 508 that executes software 510. The software 510 may be configured to process and manage cart tracking data. The processing unit 508 may be in communication with a memory 512, I/O unit 514, and storage unit 516 that may store one or more databases, flat files, or other data storage files. The I/O unit 514 may be configured to communicate locally with the shopping cart IR receiver 504 using a local wireless or wireline communications protocol, or remotely via a communications network, such as the Internet, mobile telephone communications network, satellite communications network, or combination thereof using the appropriate communications protocols.

The shopping cart IR receiver 504 may be configured with a processing unit 518 that executes software 520. The processing unit may be in communication with a memory 522, one or more IR sensors 524, I/O unit 526, and clock 528. The IR sensor(s) 524 may be configured to receive IR signals 530a-530n (collectively 530) communicated from the IR tags 506 positioned on shelves and other locations in the retail store. The clock 528 may be a real-time clock (e.g., date and time) and be configured to generate clock data signals for the processing unit 518 to timestamp data received from the IR tags 506 via the IR sensor(s) 504. Alternatively, the clock 528 may be a clock that provides relative time without being associated with time-of-day.

The IR tags 506 may be configured with a processing unit 532 that executes software (not shown) to operate the IR tags 506. The processing unit 532 may be in communication with a memory 534 and IR transmitter 536. The IR transmitter 536 may be configured to generate one or more IR signal 530 for the IR sensor(s) 524 on the shopping cart IR receiver 504 to receive. In an alternative embodiment, rather than including a processing unit 532, IR tags that have a configuration similar to a television remote control that does not use a processing unit may be utilized to perform the same or analogous functionality as described with regard to the IR tags 506. The IR signals 530 may include IR tag data 538a-538n (collectively 538) that includes an IR tag ID that is unique within the retail store to identify which of the particular IR tags 506 in the retail store is communicating the IR signal. In addition, if the configuration of the IR transmitter 536 includes a left, right, and center IR light emitting diode (LED), the IR signal 530 may include a left, right, and/or center indicator that enables the processing unit 518 to collect direction of travel information without having to perform processing to determine direction.

In operation, as a shopper is pushing a shopping cart through a retail store, the IR tags 506 are communicating IR tag data 538 via the IR signals 530. As the shopping cart IR receiver 504 is pushed in the field-of-view of the IR signals 530, the IR sensor(s) 524 receive the IR tag data 538. The processing unit 518, in response to receiving the IR tag data 538 via the IR signals 530, may timestamp the IR tag data 538 and store the timestamped IR tag data, which is now data that is representative of cart movement (i.e., cart data or cart tracking data), in the memory 522. The processing unit 518 may be configured to store the cart data for later communication to the shopping cart tracking system server 502. In one embodiment, cart data 540, which may be the timestamped IR tag data, may be communicated to the shopping cart tracking system server 502 via a communications path 542, such as a wireless communications path (e.g., 802.11 communications protocol), (ii) hardwire communications path, or (iii) portable device (e.g., laptop computer) that, in turn, communicates the timestamped IR tag data to the shopping cart tracking system server 502 using a wireless or hardwired communications protocol. If the processing unit 518 processes the timestamped IR tag data to generate summary shopping cart tracking data or otherwise, then that cart data 540 may also be communicated to the shopping cart tracking system server 502. Alternatively, rather than using the shopping cart tracking system server 502, the portable device or non-portable device (e.g., desktop computer) may be utilized to perform the same or analogous functionality as the shopping cart tracking system server 502.

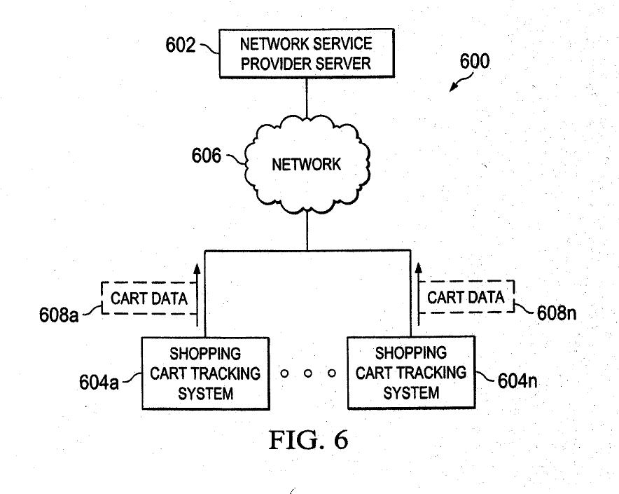

With regard to FIG. 6, an illustration of an illustrative network environment 600 is shown to include a network service provider server 602 that is in communication with shopping cart tracking systems 604a-604n (collectively 604) via communications network 606. The communications network 606 may be the Internet, mobile communications network, and/or satellite communications network. As described with regard to FIG. 5, the shopping cart tracking systems 604 may be configured to collect and/or process shopping cart tracking data from shopping carts and baskets that are moved around retail stores. In one embodiment, the shopping cart tracking systems 604 are operated at different stores of the same retailer. Alternatively, the shopping cart tracking systems 604 may be operated at different stores of different retailers. Cart data 608a-608n (collectively 608) may be communicated via the network 606 by the shopping cart tracking systems 604 to the network service provider server 602. In one embodiment, the cart data 608 may be communicated using a standard data file format, such as a comma-separated values (CSV) format. Although not shown, the network service provider 602 may be configured to include a computing system, such as a server, that includes processing unit that executes software that collects and processes the cart data 608 and stores the processed cart data 608 in a data repository. The processed cart data may be used to determine where to position electronic displays that form the out-of-home television network in the respective retail store(s) and determine media metrics of the out-of-home television networks, as described herein.

With regard to FIGS. 2, 5, and 6, a process of tracking a shopping cart and generating shopping cart metrics is provided. FIG. 2 shows a retail store 200 with the shopper pathway 216 taken by a shopper. When the shopper enters the retail store 200 with a shopping cart equipped with the shopping cart IR receiver 504, the shopping cart IR receiver 504 receives IR tag data, such as IR tag data 538a, from an IR tag, such as IR tag 506a. The IR tag data associated with each of the IR tags 506 may have an IR tag identifier with the numbered IR tags or sensors (e.g., 1-134), which are associated with zones (e.g., 1-134), as shown on FIG. 2. By timestamping the IR tag data 538 when received, the velocity (distance/time) of the shopper may be computed along the shopper pathway 216.

As the shopper pathway 216 shows, the customer passed through the following zones:

A (store entrance) 133-134-132-112-110-11-9-25-24-23-26-27-28-31-30-29-37-36-35-42-41-40-43-46-47-48-88-87-85-51-50-49-55-56-57-82-81-80-79 -76-77-78-72-71-70-90-64-65-66-60-59-58-89-117-92-93-94-101-100-99-98-131-124-125-126 B4-B3 (Checkout Area).

TABLE I below provides for shopping cart metrics collected and generated by the shopping cart tracking system 500 (FIG. 5) and, optionally, the network service provider server 602. The first column of TABLE I indicates the path traversed through the retail store 200 by the shopper as provided by the shopper pathway 216 in FIG. 2. A zone is the area associated with a specific sensor. For example, two adjacent zones may be to the left and right of an IR tag. Alternatively, the IR tag may be centered within a zone. Alternative zone and IR tag configurations may be utilized in accordance with the principles of the present invention (e.g., IR tags positioned above (mounted or suspended from the ceiling) or below the zones (e.g., mounted to the floor)). The second column shows the timestamps, which indicate the time, which may be real-time or relative time, that the shopper passed each of the respective sensors. The third column indicates the calculated time, in seconds, that the shopper took to travel from the previous zone to the current zone. The calculated time may be from zone-edge to zone-edge or zone-center to zone-center depending on the configuration of the IR tags. The fourth column indicates the distance, in feet, from the previous zone to the current zone. Again, the distance may be from zone-edge to zone-edge or zone-center to zone-center depending on the configuration of the IR tags. The fifth column calculates velocity in feet per second calculated as the distance from the previous zone to the current zone divided by the time that it took to travel that distance.

TABLE I
Cart Track with Time Stamps for FIG. 2

| | | Elapsed | | |
|---|---|---|---|---|
| | | Time | Distance | |
| | | from | from | |
| | | Previous | previous | |
| | | Zone | zone | Velocity |
| Zone | Time | (seconds) | (feet) | (feet/sec) |
| A (Store | 10:12:25 | 0 | 0 | — |
| Entrance) | | | | |
| 133 | 10:12:41 | 16 | 15 | 0.94 |
| 134 | 10:12:51 | 10 | 15 | 1.15 |
| 132 | 10:13:45 | 54 | 15 | 0.47 |
| 112 | 10:14:01 | 16 | 18 | 0.47 |
| 110 | 10:14:12 | 11 | 15 | 1.22 |
| 11 | 10:14:24 | 13 | 25 | 1.67 |
| 9 | 10:14:30 | 16 | 6 | 1.07 |
| 25 | 10:14:46 | 16 | 12 | 0.56 |
| 24 | 10:16:00 | 14 | 5 | 0.57 |
| 23 | 10:16:46 | 46 | 5 | 0.17 |
| 26 | 10:16:56 | 10 | 8 | 0.23 |
| 27 | 10:17:07 | 11 | 5 | 0.62 |
| 28 | 10:17:18 | 11 | 5 | 0.45 |
| 31 | 10:17:30 | 12 | 8 | 0.57 |
| 30 | 10:18:30 | 60 | 5 | 0.18 |
| 29 | 10:18:38 | 8 | 5 | 0.15 |
| 37 | 10:18:48 | 10 | 7 | 0.67 |
| 36 | 10:19:50 | 62 | 15 | 0.31 |
| 35 | 10:20:45 | 55 | 15 | 0.26 |
| 42 | 10:20:59 | 14 | 10 | 0.36 |
| 41 | 10:21:15 | 16 | 15 | 0.83 |
| 40 | 10:21:25 | 10 | 15 | 1.15 |
| 43 | 10:21:50 | 25 | 18 | 0.94 |
| 46 | 10:21:58 | 8 | 10 | 0.85 |
| 47 | 10:22:20 | 22 | 25 | 1.17 |
| 48 | 10:24:00 | 40 | 25 | 0.81 |
| 88 | 10:24:16 | 16 | 20 | 0.80 |
| 87 | 10:25:12 | 56 | 10 | 0.42 |
| 85 | 10:26:01 | 49 | 10 | 0.19 |
| 51 | 10:26:13 | 12 | 11 | 0.34 |
| 50 | 10:26:30 | 17 | 25 | 1.24 |
| 49 | 10:27:28 | 58 | 25 | 0.67 |
| 55 | 10:27:56 | 28 | 20 | 0.52 |
| 56 | 10:28:56 | 60 | 25 | 0.51 |
| 57 | 10:29:25 | 29 | 25 | 0.56 |
| 82 | 10:29:35 | 10 | 8 | 0.85 |
| 81 | 10:29:42 | 7 | 8 | 0.94 |
| 80 | 10:29:52 | 10 | 10 | 1.06 |
| 79 | 10:30:01 | 9 | 10 | 1.05 |
| 76 | 10:31:10 | 9 | 8 | 1.00 |
| 77 | 10:31:16 | 6 | 10 | 1.20 |
| 78 | 10:32:00 | 44 | 10 | 0.40 |
| 72 | 10:32:35 | 35 | 12 | 0.28 |
| 71 | 10:32:46 | 11 | 10 | 0.48 |
| 70 | 10:32:56 | 10 | 10 | 0.95 |
| 90 | 10:33:03 | 7 | 6 | 0.94 |
| 64 | 10:33:16 | 13 | 10 | 0.80 |
| 65 | 10:32:21 | 9 | 10 | 0.91 |
| 66 | 10:32:31 | 10 | 10 | 1.05 |
| 60 | 10:32:52 | 21 | 12 | 0.71 |
| 59 | 10:33:12 | 20 | 10 | 0.54 |
| 58 | 10:32:02 | 50 | 10 | 0.29 |
| 89 | 10:32:08 | 6 | 5 | 0.27 |
| 117 | 10:32:12 | 4 | 5 | 1.00 |
| 92 | 10:33:12 | 60 | 5 | 0.16 |
| 93 | 10:34:00 | 48 | 25 | 0.28 |
| 94 | 10:36:20 | 140 | 25 | 0.27 |
| 101 | 10:36:31 | 11 | 20 | 0.30 |
| 100 | 10:36:58 | 27 | 8 | 0.74 |
| 99 | 10:38:02 | 64 | 25 | 0.36 |
| 98 | 10:39:14 | 72 | 25 | 0.37 |
| 131 | 10:39:44 | 30 | 18 | 0.42 |
| 124 | 10:39:50 | 6 | 8 | 0.72 |
| 125 | 10:40:03 | 13 | 8 | 0.84 |
| 126 | 10:41:10 | 57 | 8 | 0.23 |
| B4 | 10:41:41 | 31 | 20 | 0.32 |
| (Checkout) | | | | |
| B3 | 10:42:10 | 29 | 20 | 0.67 |
| (Checkout) | | | | |

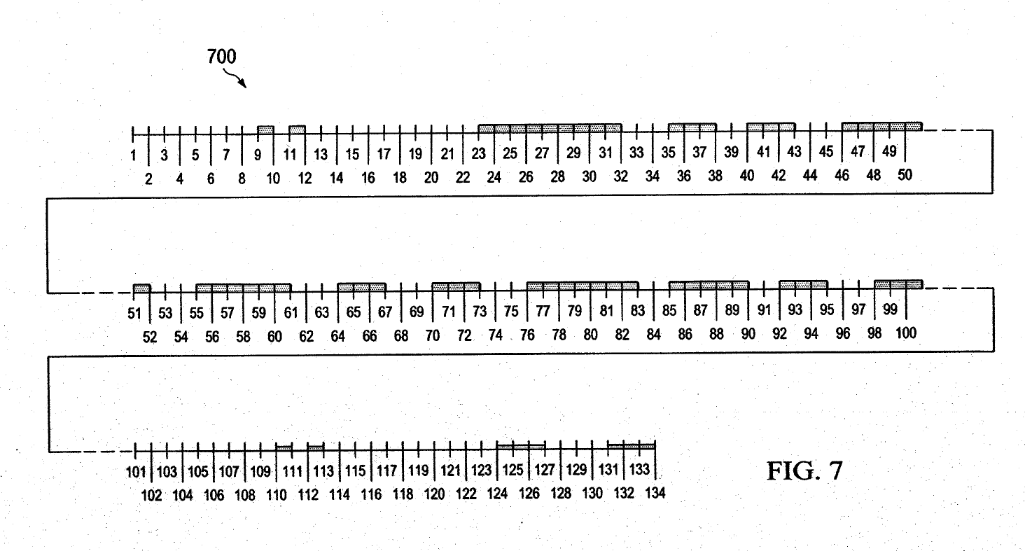

Based on the path information collected and generated by the shopping cart IR receiver 504, shopping cart tracking system server 502, and/or network service provider server 602, graphs that indicate path and velocity may be generated, as provided in FIGS. 7-11.

With regard to FIG. 7, a chart of illustrative shopping cart position data 700 indicative of which particular zones the shopper of FIG. 2 traveled. Note that the order in which the customer passed through a zone is not indicated by this chart. Only the fact that the customer passed or traveled through a zone is indicated.

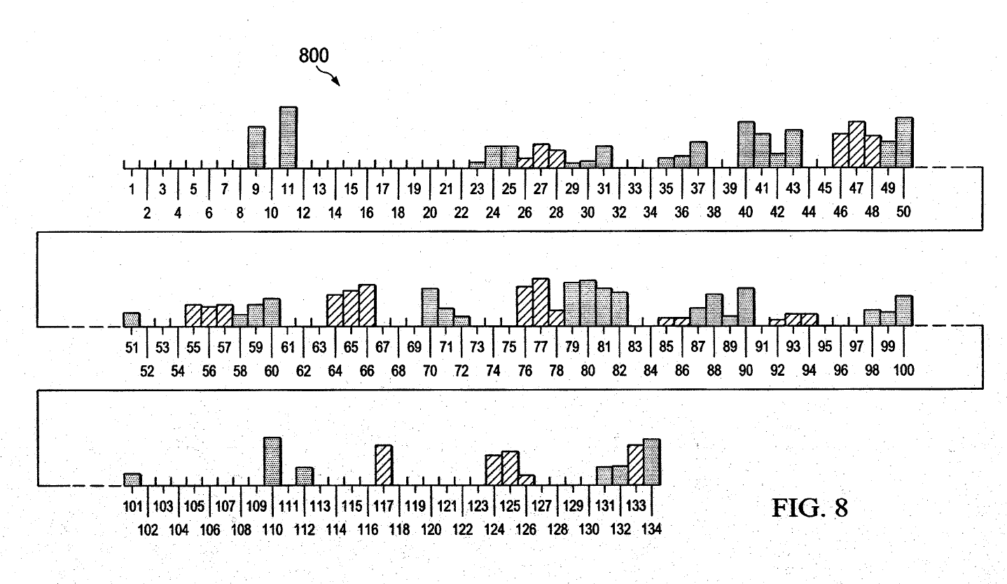

With regard to FIG. 8, a chart of illustrative shopping cart velocity data 800 representative of the velocities that the shopper of FIG. 2 traveled through the zones identified in FIG. 7 and listed in TABLE I are shown. The velocities may be calculated in feet per second or feet per minute, for example, to correspond with data units used for calculating viewing distance from electronic displays to calculate locations to position electronic displays of out-of-home television network. Note that areas through which the shopper passes in one direction are indicated by a dotted pattern, and areas through which the shopper passes in another direction are indicated by a striped pattern. The height of the bar indicates velocity.

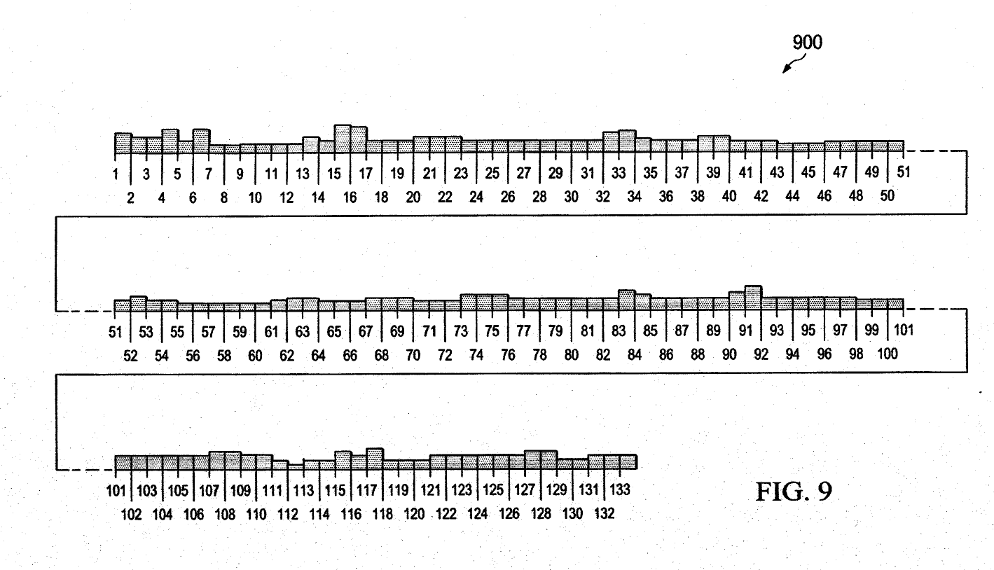

With regard to FIGS. 9, 10, and 11, graphs of illustrative shopper metrics are shown. The shopper metrics may be accumulated, averaged, or otherwise processed for cart data collected over each of the zones in the retail store 200 (FIG. 2).

FIG. 9 is a chart of illustrative shopping cart data 900 shows a total number of shoppers that enter each of the zones in the retail store 200 during a time period (e.g., between the hours of 3 pm to 6 pm, during a single day, during a week).

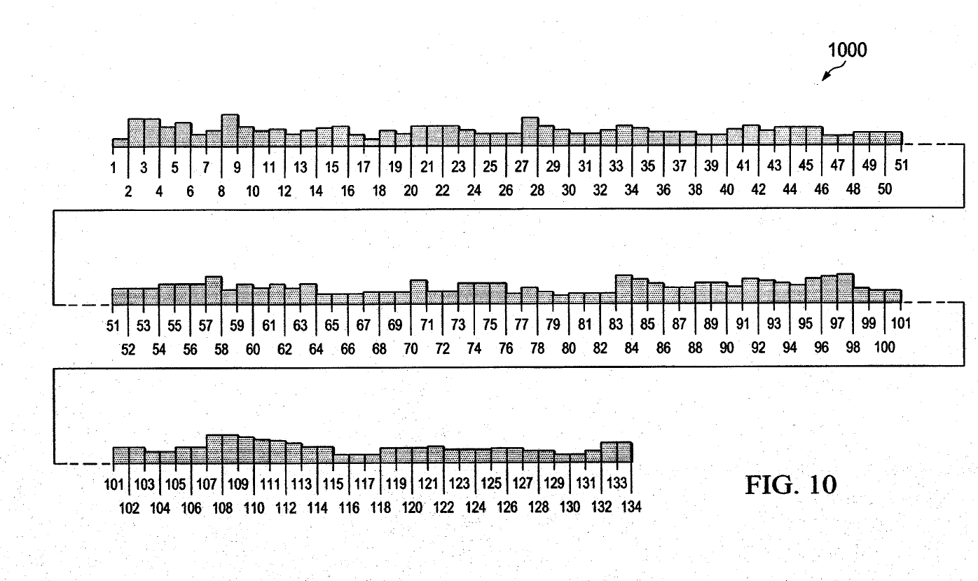

FIG. 10 is a chart of illustrative average velocity data 1000 indicative of shopper velocities through each of the zones. The total average velocity data 1000 does not indicate which direction the shoppers are traveling.

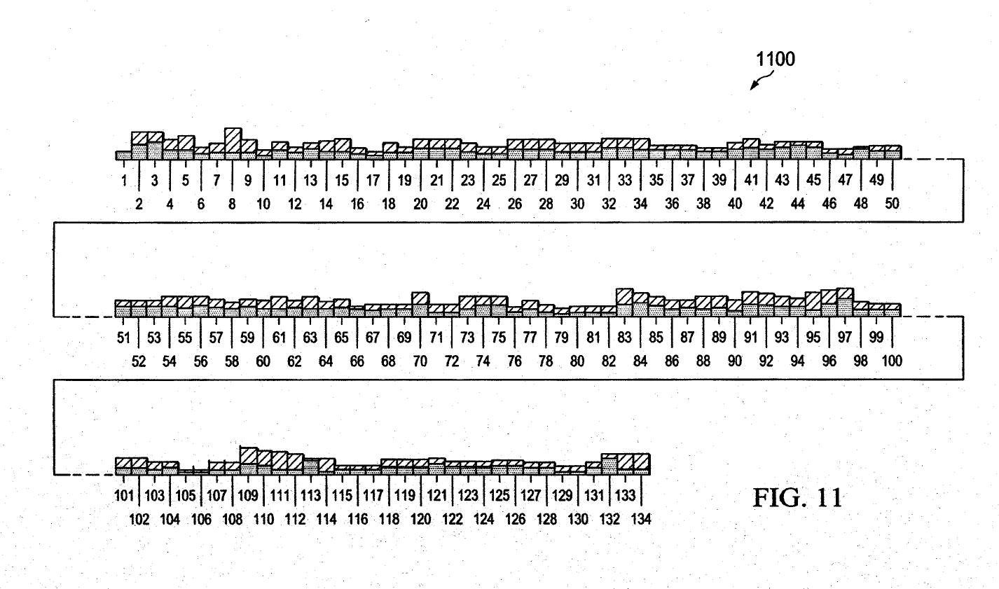

FIG. 11 is a chart of illustrative directional average velocity data 1100 that indicates both direction and velocity in the respective direction of shoppers that passed through the respective zones. As shown, the dotted portion of the bars represent shoppers traveling in one direction and the diagonally striped portion of the bars represent shoppers traveling in the opposite direction.

With further reference to FIG. 2, it can be seen that all shoppers enter the store at zone A, near zone 133, which is just to the right (below) the front entrance. Therefore, it is to be expected that more shoppers passed from zone 133 to zone 134, rather than from zone 134 to zone 133. This is indicated on FIG. 11, which shows that the dotted area at sensors 133 and 134 are much larger than the striped area. Very few shoppers pass zones 105 and 106, which are at the lower right of FIG. 2. This shopper measurement result is not unexpected since shoppers do not enter these zones unless they specifically want to purchase products that are in these zones. It can be seen that in most aisles that shopper velocity is approximately the same in both directions (i.e., the striped and the dotted area are substantially the same height).

By compiling cart tracking information from multiple shoppers, a chart showing the number of shoppers that passed through zones (See, FIG. 9) and a chart showing the average velocity of shoppers passing through zones (See, FIGS. 10 and 11) can be generated. Note that the charts in FIGS. 7-11 may be generated for specific time slices. As an example, tracking shoppers' velocity between 2:00 PM and 4:00 PM on Wednesday could be performed.

A variety of decisions may be made in configuring and operating the out-of-home television network based on the shopper metric data collected and generated by the shopping cart tracking system and, optionally, remote computing system, such as the network service provider server 602 (FIG. 6). For example, location of the electronic displays of the out-of-home television network may be established. Zones in which the electronic displays service may be set. Airtime segments may be determined to maximize average shopping trip time. Number of airtime segments in an ad “wheel” and length of the ad “wheel” may be set and determination what percentage or total number of the available shoppers in out-of-home television network are actually delivered. Additional configuration parameters and operating metrics may be set based on the shopper metrics.

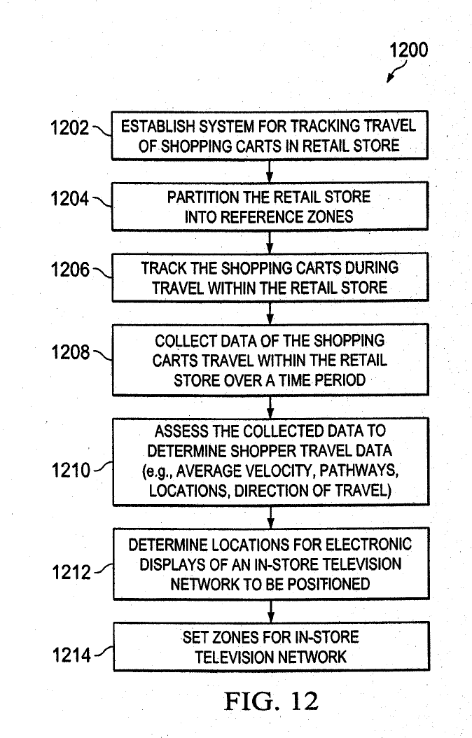

With regard to FIG. 12, an illustrative process 1200 for determining positioning of electronic displays in an electronic display network is shown. The process 1202 starts at step 1202, where a system for tracking travel of shopping carts in a retail store may be established. The system may be one of the systems described with respect to FIG. 3 or 4. In one embodiment, the system may be configured to track position and time at which position samples are taken. The shopping cart tracking system may utilize RF signals, IR signals, or any other electromagnetic or optical signals that may be used to track shopping carts and baskets that are being pushed or carried around the retail store. The shopping cart tracking system may utilize active (i.e., powered) or passive (i.e., unpowered) RFID or IR tags, as understood in the art.

At step 1204, the retail store may be partitioned into reference zones. A variety of different reference zone configurations may be utilized. If the retail store or a new retail store configuration is being measured for the first time, then shorter reference zones may be utilized to provide more resolution. If the retail store configuration has been measured in the past, then longer reference zones may be utilized since the network service provider or 3^{rd} party ratings provider may already have a basic idea of shopper traffic flow in that retail store configuration. In one embodiment, the reference zones may be formed of regularly spaced rows and columns, such as those provided in a planogram, as understood in the art. Alternatively, non-regular reference zones may be utilized. Still yet, the reference zones may be configured according to product category. Non-categorically arranged reference zones may alternatively be utilized.

At step 1206, tracking of the shopping carts may be performed. The tracking may begin at the beginning of the shopping trip and end at the cash register or when the shopper leaves the tagged shopping cart within the store without purchase. The tracking system may record each unique shopper as the shopping cart is pushed through the zones in the store. Velocity of travel may be determined, as well. In the course of a single shopping trip, it is understood that a shopper may repeat or re-circuit various areas of the store, and such movement may be tracked. It should be understood that the shopping cart tracking system may be configured to perform certain processing, such as determining total shopping time, velocity through zones, average velocity through the store, direction of travel through zones, and so on. In an alternative embodiment, another computer system may be configured to receive “raw” data collected by the shopping cart tracking system and perform the processing.

In addition to the processing for determining various shopper metrics about the shopper while shopping, another metric that retailers have heretofore been unable to quantitatively determine is the amount of time it takes shoppers to pass through a checkout station, either via a personnel operated cash register or self-checkout system. In one embodiment, each of the checkout lines may be configured as a zone so that shoppers that enter the respective zones may be tracked for the time that the shopper takes to pass through the zone. Because the shoppers are no longer potential purchasers, information about the time taken to pass through the checkout line is substantially inconsequential for media metrics purposes. However, the checkout line data may be helpful for retail store operators to improve efficiency of their retail store operations.

At step 1208, the data of the shopping carts movement through the retail store over a time period may be collected. The time period may be any time period desired by a user or be configured to automatically collect the data for a predetermined time period, such as one week. The data collected may include positions of the shopping carts and timestamps along with each of the positions within the retail store. In addition, data representative of the pathways, directional movement, velocity of travel within each zone may be collected, as well. Whether the data is collected by the shopping cart IR receiver or at a remote system by using RF triangulation techniques, the collected data may be communicated to a remote location for further processing to aggregate shopping cart tracking data from multiple shopping carts.

At step 1210, the collected data may be assessed. The assessment may include determining average shopper travel velocity, pathways that shoppers aggregate, locations, and direction of travel that shoppers travel within the zones, for example. Additional information may be assessed, as well.

At step 1212, a determination may be made as to locations for electronic displays of an in-store television network to be positioned. The determination may be made based on parameters of electronic displays and traffic patterns of shoppers that travel through common zones in the retail store. If, for example, 80% of shoppers travel through a certain pathway, then at least one electronic display may be positioned to capture that traffic. Based on an average amount of time that shoppers spend in the zone, a determination may be made as to how many airtime segments may be viewed on the electronic display(s) positioned to service that zone. There is a balance between having too many and too few electronic displays to provide opportunities for customers to view the airtime segments, where the balance is made based on the parameters of the electronic displays (e.g., size of electronic display, resolution, contrast, etc.) and traffic flow.

At step 1214, zones may be set for the in-store television network. Based on the shopper traffic flow determined in FIG. 12, a determination may be made to adjust or define new zones that each electronic display is to service. For example, if the reference zones of step 1204 are initially set as a grid used for planogram purposes, the zones may be set to match distances that shoppers are able to view the electronic displays that are positioned with respect to the shopper traffic. As an example, if an electronic display has the ability to be viewed 40 feet away, then one electronic display may be place at the ends of each aisle as opposed to using an electronic display with a 20 foot viewing distance that would necessitate one electronic display in the middle and one at the end of the aisle. In using the electronic displays with the 40 foot viewing distance, then a single zone may be positioned along the entire length of the aisle.

The process 1200 of FIG. 12 may be utilized for initially measuring and configuring a retail store with an in-store television network. If the retailer rearranges the store layout or product locations, then the process 1200 may be repeated to reconfigure the in-store television network. It should be understood that software may be used to reduce the initial 200 zones to less than 12 major zones, for example, where shoppers flow together. Other number of zones may be utilized for determining shopper tracking data. For example, it may be determined that in a particular pathway of 30 feet in length, an average shopper could view 10 twenty-second video messages. It is also logical to understand that an average shopper traveling along the same pathway could view 20 ten-second video messages in the same viewing distance. Once this database is developed, the software may locate the minimum placement points in the store for the placement of the electronic displays or television screens, based on size of screens, image viewable-distance, and aggregate viewers in each pathway, in order that a predetermined number of video messages are seen by the shopper in course of an average shopping trip. The software may also determine that such placement may yield an audience delivery percentage, up to 100% or higher because of shopper re-circuiting, as related to transaction data collected.

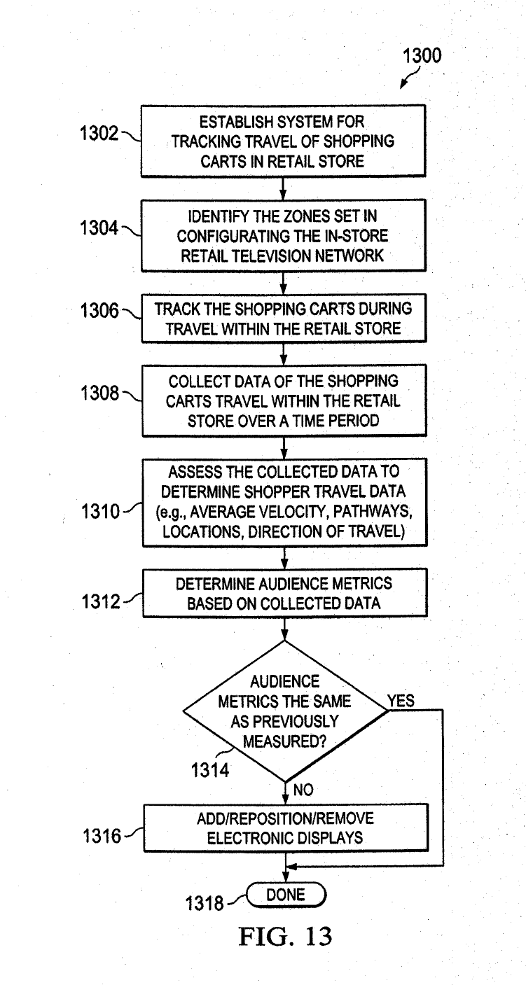

With regard to FIG. 13, a flow diagram of an illustrative process 1300 for determining or recertifying audience metrics of an in-store television network is provided. The process 1300 starts at step 1302, where a system for tracking travel of shopping carts in a retail store may be established. If the system provided in step 1202 of FIG. 12 is still in place, then that system may be utilized. At step 1304, the zones set in configuring the in-store retail television network may be identified. The zones set may be set in step 1214 of FIG. 12. As step 1306, the shopping carts may be tracked during travel within the retail store by the shopping cart tracking system. At step 1308, data of the shopping carts travel within the retail store over a time period may be collected. The collection may be performed over selected times by a user, such as daily or weekly. At step 1310, an assessment of the collected data to determine shopper travel data (e.g., average velocity, pathways, locations, direction of travel) may be performed. Audience metrics based on the collected data may be determined at step 1312. The audience metrics may include audience reach (number of viewers that had the opportunity to view each airtime segment) and frequency of view of the airtime segments while shopping. The audience metrics may be made on a zone-by-zone basis, store basis, or any other basis.

At step 1314, a determination may be made as to whether the audience metrics are the same or substantially the same (i.e., within a couple of percentage points) as previously measured. The previous measurement may be the measurement made when setting up the in-store television network. If not, the process continues at step 1316, where addition, repositioning, or removal of the electronic displays may be performed based on the shopper traffic and electronic displays, as previously described with respect to FIG. 12. Otherwise, the process ends at step 1318.

Resulting from the process 1300, a network service provider may recertify that placement of the electronic displays and the zones originally established for the electronic displays are still adequate for delivering an audience. The measurement scheme utilizing shopper velocity data may be used to certify or determine an actual number of video messages (e.g., 10-second advertisements) that a shopper can view in each zone as the shoppers travel in the store. The audience tally or reach may now be established and certified by the tracking process while re-sampling may be used to assure that the previous data assessments remain correct. If the re-sampling determines directional changes, aggregate flow changes, shopper velocity changes, and/or shopper pathway changes, the placement of the television screens may be adjusted to properly deliver media metrics (i.e., reach and frequency, delivery) that advertisers and agencies are sold. It should be understood that other factors may be used to instigate re-sampling, including changes to product placement within the retail store, changing of store layout, seasonal changes (e.g., summer versus winter), and so forth.

The process described in FIGS. 12 and 13 above may be installed in a retail store and portions may be embodied in software that is executed by a computing system, such as the network service provider server 602. It should be understood that additional or different process steps may be utilized to provide for the same or analogous functionality in accordance with the principles of the present invention. Alternative zones defined in FIGS. 3 and 4 may be utilized. As shown, the zones may have different dimensions. Although shown as being aligned across the aisles, it should be understood that the zones may have different or irregular shapes and dimensions. Resulting from the illustrative process may be the ability for the out-of-home television provider to specify specific locations for the electronic displays to be positioned within the retail store to deliver a predetermined audience reach and frequency of view of a message or advertisement. If a retail chain uses the same configuration for each of its chain stores, one or more store samplings may be used for specifying the locations of the electronic displays to provide reasonable expectation that media metrics across the entire retail chain will be satisfied (i.e., audience reach, frequency, and delivery will be approximately the same in each of the retail stores).

As described above, Nielsen in-home television measures aggregate programming viewership within predetermined time allotments. Through the use of the above-described process, the same metrics can now be determined in the out-of-home television environment. The principles of the present invention certify that the audience viewership in a retail establishment, or one or more retail chains, is factually delivered in a methodologically sound form, while accommodating differential shopper traffic flows in separate retail locations, whereby traditional media assessments and purchasing can be performed by those individuals familiar with assessing and purchasing in-home television as is known in the art. Such measurement permits traditional arithmetic and quotient-based ratings assessments as is known in the art.

While Nielsen measures common viewer blocks of time within in-home television programming whereby viewership is sampled, the principles of the present invention measures common zones of travel through product offering, or retail-style programming, within a retail location and time traveled within the zones whereby viewership is sampled. As a result, media metrics for the out-of-home television network match, or are substantially similar to Nielsen's media metrics for in-home television so that advertisers and media agencies are provided with information that is readily understandable.

The shopper metrics collected from the process of FIGS. 12 and 13 may be presented to a user in a variety of different formats. Graphs, such as those shown in FIGS. 7-11, may be used. Charts, such as TABLE I, may be utilized. Graphics, such as those shown in FIG. 4 showing zones and data on each of the zones, may be utilized. It should be understood that a wide variety of reporting may be presented to the user. Data that may be included in a report selectable by a user over a certain time period may include the following illustrative data:

(i) the specific path taken during any of the monitored shopping trips;

(ii) the velocity with which a shopper passed any of the sensors;

(iii) number of shoppers who pass a particular sensor during a specific period of time;

(iv) direction of shoppers. As an example, a determination may be made as to how many shoppers passed a specific location moving from left to right versus how many shoppers passed from right to left;

(v) average velocity of shoppers passing a particular sensor in each direction;

(vi) how many shoppers at least partially re-circuit the store

(vii) number of ads viewed in each zone based on average speed of shoppers in each zone;

(viii) number of ads viewed in the retail store based on average speed of shoppers in the retail store;

(ix) feet traveled in the retail store;

(x) incomplete trips of shoppers (i.e., shoppers who stop shopping and leave without purchasing; and

(xi) average time to pass through checkout on a per employee or line basis.

The end result of using the system and methodologies described herein provides data that may be used to generate a linear function of viewing time and distance of audience members (i.e., shoppers). By generating the linear function, positioning of electronic displays may be made in such a way that maximizes viewership and minimizes the number of electronic displays, thereby producing an in-store network that has an audience that includes substantially every shopper that enters the store in a cost effective manner. In one embodiment, a calculation may be made in the following manner: 50 ads/wheel×7 second ads/60 seconds/minute=5.8 minutes×3 views per ad=17.5 minutes of viewing time that has to be aggregated. To account for the full 17.5 minutes of viewing time, zones over which a certain percentage of shoppers travel and spend a determined amount of time using the tracking system may be determined for placement of the electronic displays. By tracking shopper traffic, a scientific methodology may result in accurate audience measurement, which allows a network service provider to accurately position the electronic displays, retailers to better design their stores, advertisers to monitor effectiveness of their advertising, and advertising media agencies to plan and buy the retail-based audience delivery with metrics that are substantially similar to traditional television metrics for planning and buying audiences.

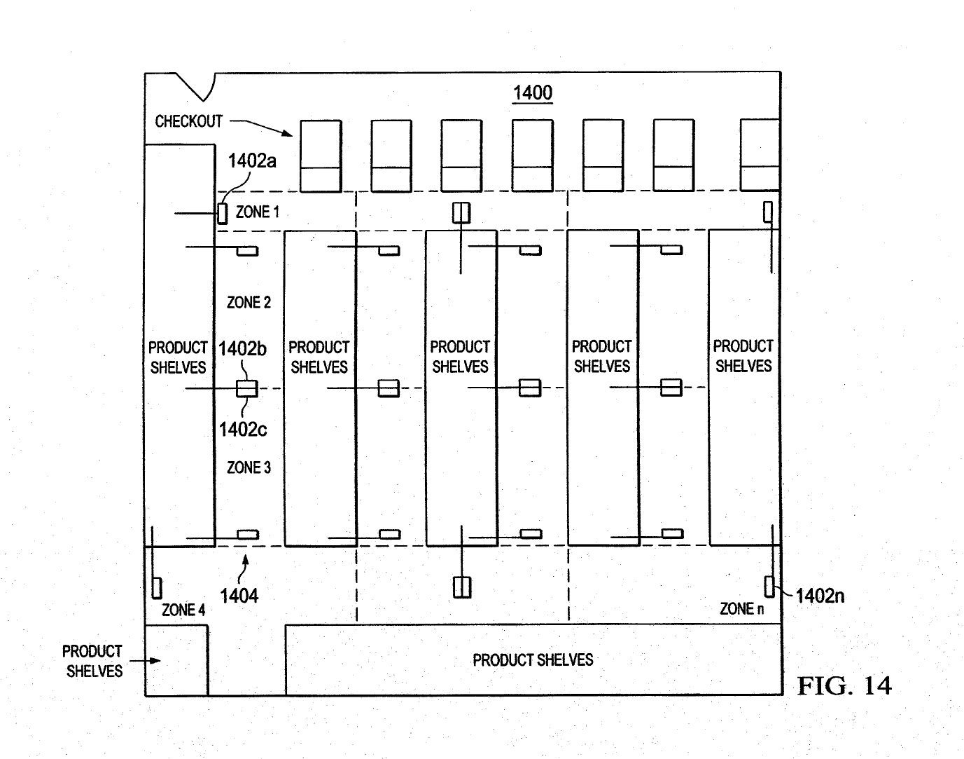

With regard to FIG. 14, a floor plan representation of the illustrative retail store 400 of FIG. 4 is shown. In this embodiment, electronic displays 1402a-1402n (collectively 1402) may be positioned throughout the retail store 400 based on measurements by a shopping cart tracking system and electronic display parameters. Zones may be established that each of the electronic displays 1402 service. Electronic displays 1402b and 1402c may be connected to the same extension arm and be placed back-to-back so that shoppers traveling different directions along aisle 1404 may have an opportunity to view respective electronic displays 1402b and 1402c. The electronic displays 1402 may be automatically positioned on the floor plan representation. Alternatively, the electronic displays 1402 may be manually positioned on the floor plan representation by a user who is provided a report with corresponding numerical values that identify locations on the floor plan to position the electronic displays and percentage of audience reach or delivery. In determining where to place the electronic displays, a criteria may be set such that an electronic displays is substantially always in sight of a shopper so that a positive determination may be made that each shopper has an opportunity to view each airtime segment (e.g., advertisement video clip) throughout the entire retail store.

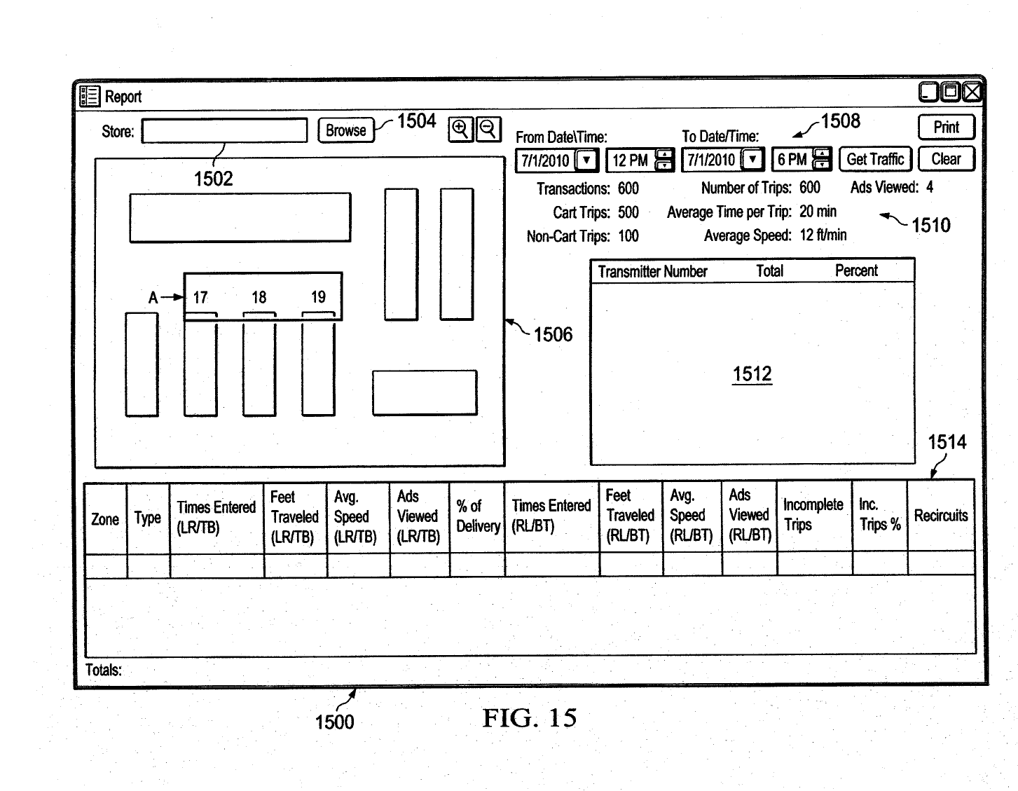

With regard to FIG. 15, an illustrative graphical user interface (GUI) 1500 is shown. The GUI 1500 may operate as a front-end system for a database, such as an Oracle database that stores data collected from IR receivers, such as shopping cart IR receiver 504 (FIG. 5). As shown in the GUI 1500, a user may enter a store identifier in an entry field 1502, where the store identifier is associated with a graphical representation of a floor plan. In one embodiment, a “browse” soft-button 1504 may be provided to enable the user to browse through a directory to locate an image file associated with the retail store. In response to the user selecting the image file, a graphical representation of a store layout 1506 may be presented to the user.

The GUI 1500 may be interactive in that a user may have the ability to draw zones, such as zone A displayed on the store layout 1506. As shown, zone A includes at least a portion of IR tags 17, 18, and 19. As described below, shopper data that is collected by the IR receivers that includes IR tags 17, 18, and 19 being detected may be associated with zone A.

As further shown in FIG. 15, report input data fields 1508 may be used to enable the user to select what report parameters to use to view shopper data. The input data fields 1508 may include “From Date/Time” and “To Date/Time” selectable data entries. Shopper data 1510 may be displayed so that the user can view how many transactions, number of cart trips, number of non-cart trips, number of total trips, average time per trip, average speed, and number of ads viewed (frequency) by each shopper based on the shopper data 1510. Although shown as being equal, the number of transactions and number of trips may be unequal if for example, shoppers made more or fewer transactions than pushed carts or carried baskets. In addition, a table 1512 listing data specifically associated with each transmitter may be presented to the user. The table 1512 may include “Transmitter Number,” “Total,” and “Percent.” The “total” may indicate the total number of shoppers that entered and/or exited a zone in which a transmitter is associated. The “percent” may represent the percentage of all shoppers that entered a zone associated with a transmitter. Rather than using “transmitter number” as a data field, “zone number” or “grid coordinates” may alternatively be used.

In addition, another table 1514 may be presented to the user to display detailed shopper data. The shopper data may include: “Zone,” “Type,” “Times Entered,” “Feet Traveled,” “Avg. Speed,” “Ads Viewed,” “% of Delivery,” “Times Entered,” “Feet Traveled,” “Avg. Speed,” “Ads Viewed,” “Incomplete Trips,” “Incomplete Trips %,” “Recircuits.” The table may show whether the shopper entered from the left, right, top, or bottom of the zone to provide additional traffic pattern information. Incomplete trips are indicative of shoppers start shopping, but leave without completing a transaction (e.g., leaving the cart in the store without passing through checkout). As shown, the shopper data is shown on a per zone basis. It should be understood, however, that alternative bases may be used to present the data in accordance with the principles of the present invention. Ultimately, the shopper data displayed may be used to assist the user in defining zones that may be used to identify where a certain percentage of shoppers (e.g., 100%) (reach) travel so that each shopper has the ability to view each airtime segment a certain number of times (frequency of view).

The process provided in associated with FIG. 15 is a manual process. However, it should be understood that an automated process may be created to determine where specific zones are to be positioned to minimize total number of zones and electronic displays. In automating the process, the zones may be started at the entrance and expand therefrom depending on the store configuration. For example, a zone may be established at the entryway, a next zone may be positioned along an aisle that extends from the entryway, a zone may be positioned in an aisle that extends from the aisle in-line with the entryway, and so forth. Electronic displays with different operating parameters may be used to have long or short zones that align with traffic flow in the retail environment.

With further reference to FIG. 4, an illustration of one embodiment of a cart tracking system that uses of IR transmitters and IR receivers is shown. The term IR transmitter is also considered an IR transmitter device, and the term IR receiver is also considered an IR transmitter device. Rather than using a few (e.g., three) receivers as in the case of using RF triangulation technology, many IR transmitters or tags 410 may be positioned throughout aisles and other pathways throughout the retail store to transmit IR signals that are received by the IR receiver 408 that that is mounted to the shopping cart 406. As a shopper pushes the cart 406, the IR receiver 408, which may be connect to a front member of a shopping cart, collects IR tag codes that identify each IR tag 410 and generates timestamps, either real-time (i.e., date and time) or relative (e.g., running clock not indicative of date and time), as each IR tag code is collected. Each IR tag identifier is considered to be indicative of position or location within the retail store since the locations of the IR tags 410 within the retail store may be established when initially installed or moved. As shown, IR tags 410 are positioned at the ends and middle of each aisle. In addition, IR tags 410 may be positioned on end-caps of the product shelves or gondolas, and on fixtures in the wander areas of the store. In yet an alternative configuration, rather than mounting the IR tags 410 to shelves of the gondolas 402, the IR tags may be mounted from the ceiling or elsewhere in the retail store. It should be understood that a number of IR tags 410 may be utilized along each aisle to establish higher levels of resolution by creating more zones for tracking carts in the retail store. In still another embodiment, in addition to using zones to track the carts, one or more IR tags 410 may be placed in front of a specific product, such as a particular brand of soup, to monitor how long shopping carts are in front of the specific product, thereby providing an indication as to how long shoppers that are pushing the shopping carts spend in front of the specific product.

Each of the IR transmitters 410 are shown to have a transmission angle extending from the IR tags, where the transmission angle is established by transmission angles of LEDs that are used in the IR tags. A number of different configurations may used to establish the transmission angle of each of the IR tags, as shown in FIGS. 16A-16E.

With regard to FIG. 16A, in one embodiment, an IR tag 1600a may be configured with a single LED (not shown) or other illumination device that communicates an IR signal 1602 substantially perpendicular from the IR tag 1600a. The LED has a known transmission angle (e.g., ±22-degrees or 44-degree total angle), where the transmission angle is actually an illumination angle within which a majority of IR signal transmitted by the LED is contained, as understood in the art.

With regard to FIG. 16B, and in a second embodiment, IR tag 1600b is configured with two LEDs (not shown) that are respectively angled to the left and right, or otherwise spatially separated from one another, may generate respective IR signals 1604a and 1604b. The IR signals 1604a and 1604b may be utilized to communicate (i) the same data (e.g., IR tag code or data) to provide for a wider area of coverage (e.g., two IR signals 1604a and 1604b versus one IR signal 1602 (FIG. 16A)) or (ii) different IR tag data (e.g., IR tag code and left or right code). Using two different IR signals 1604a and 1604b better ensures that a shopping cart that passes the IR tag 1600b receives at least one of the IR signals 1604a and/or 1604b and, in the case of communicating left and right codes, allows for direction of travel to be captured.

With regard to FIG. 16C, the IR transmitter or tag 1600c may be configured with three LEDs (not shown), where one LED is perpendicular to the IR tag 1600c and two LEDs are offset to project to the left and right of perpendicular by some angle (e.g., +22.5 degrees and −22.5 degrees) to enable the IR tag 1600c to be used in different modes (i.e., either single LED mode, dual LED mode, dual LED mode with left and right codes, or tri-LED mode) to provide a user with flexibility. In the case of a tri-LED mode, each of the IR signals 1606a, 1606b, and 1606c may include a right, center, and left code, respectively. In this manner, the IR tag 1600c may be utilized to provide for zone edge detection, direction of travel determination, and time in front of specific product determination.

With regard to FIGS. 16D and 16E, the IR tag 1600c of FIG. 16C shows three LEDs 1608a, 1608b, and 1608c that are positioned at a front plate of the IR tag 1600c. The center LED 1608b may illuminate an IR signal 1606b perpendicularly (i.e., boresight) and the right and left LEDs 1608a and 1608c (from a point-of-view of the IR tag 1600c) may illuminate IR signals 1606a and 1606c at angles to the right and left of perpendicular, respectively, as shown in FIG. 16E, which is a top view of the IR transmitter shown in FIG. 2D. Alternative configurations may be utilized in accordance with the principles of the present invention. Different intensity levels of illumination may be utilized depending on range or area that is being covered by an IR tag, as further described herein.

Whether operating in (i) single LED mode, (ii) dual LED mode, (iii) dual LED mode with left/right codes, (iv) tri-LED mode, (v) tri-LED mode with left/right/center codes, or otherwise, the IR signals may be transmitted or communicated three times in a row and then shut down for a certain time duration (e.g., one second) to save battery power. In communicating the IR signals three times in a row, the IR signals may be burst or activated on and off three cycles in a row to communicate data packets that may include IR tag code and/or other data and then shut down. Alternatively, the IR signals may be turned on and the content may be communicated three times in a row during that illumination period. It should be understood that alternative communication techniques or protocols, such as communicating the IR tag codes five times in a row, using frequency shift keying, etc., may be utilized in accordance with the principles of the present invention. If using the left/right or left/right/center LED mode, then the left LED may communicate an IR signal with a “left” code, the right LED may communicate an IR signal with a “right” code, and, optionally, the center LED may communicate an IR signal with a “center” code so as to provide for directionality of movement of a shopping cart as the shopping cart passes from right to left or left to right in front of the IR tag.

The use of IR transmitter and receiver components significantly reduces cost and complexity for tracking carts throughout the retail environment, as compared to using RF triangulation technology. As further described with regard to FIG. 20, the use if IR transmitters that may be secured to the retail store shelves through the use of magnets to provide for a temporary and reconfigurable tracking system that is low cost and effective. By including the IR receiver on the shopping cart, the more expensive part of the system may be used in more limited numbers as compared to installing receivers along the aisles. In addition, by using optical signals, limited, if any, in-store calibration is needed for the system to operate.

Cart tracking provides a retailer and network service provider of an in-store media network a number of data points, including (i) zones in which shoppers travel, (ii) directions in which shoppers travel through each zone, (iii) numbers of shoppers in each zone, (iv) velocities through zones that shoppers travel, and (v) shopping trip times. The different configurations of the IR tags (i.e., single or multiple LEDs) can both be used to determine the five different data points identified above and possibly others not listed. However, computation complexity after data collection from the IR receiver on the shopping cart may be reduced by using the IR tags with two or three LEDs and communicating different left, right, and/or center codes via the left, right, and/or center LEDs, thereby enabling the IR receiver to collect data that immediately allows for determination as to whether the cart passed the IR tag from left to right or from right to left. Otherwise, in the case of using a single LED, the collection system can determine direction by sequencing the collected IR tag data, optionally on a map or data representative of a map, and determining direction of travel of the cart using that data and knowing actual positioning of the IR tags within the store or relative positioning of the IR tags with respect to one another.

In one embodiment, the IR signals may use the Sony SIRC communication protocol. Through the use of a standard protocol, a standard chipset may be utilized for communicating data, in this case IR transmitter codes, “left,” “right,” and/or “center” codes, battery voltage codes, etc.

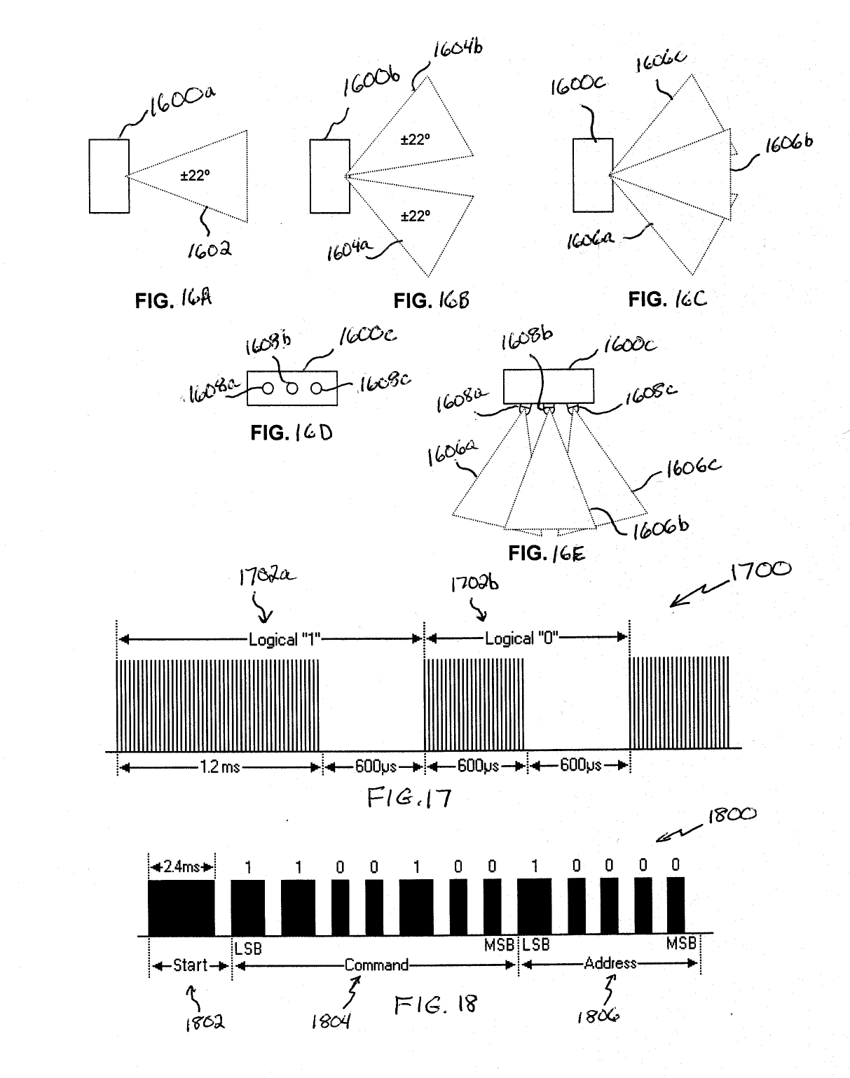

With regard to FIG. 17, a signal diagram of an illustrative data signal 1700 communicated by an IR tag is shown. The signal diagram shown uses the Sony SIRC communication protocol. It should be understood, however, that any communications protocol may be utilized in accordance with the principles of the present invention. A logical “1” 1702a is shown to be represented by a 1.2 ms pulse followed by a 600 μs (i.e., 0.6 ms) gap, while a logical “0” 1702b is shown to be represented by a 600 μs (i.e., 0.6 ms) pulse 1702b followed by a 600 μs gap within a 40 kHz carrier signal. Rather than using a 40 kHz carrier, a different carrier frequency may be utilized, such as 38 kHz.

With regard to FIG. 18, a signal diagram of an illustrative pulse train using the communications protocol of FIG. 17 is shown. As with FIG. 17, the Sony SIRC protocol is shown. Again, an alternative communications protocol may be utilized. The Sony SIRC protocol is a 12-bit protocol. To initiate a new message, a start or preamble burst 1802 is made for 2.4 ms. A 7-bit command (e.g., ‘0010011₂’ or 19₁₀) and 5-bit address (e.g., ‘0001₂’) may thereafter be transmit tag codes may range between 0 and 255, which allows for 256 IR tags in a single retail store. An extra bit may be used to provide for left or right side LED (e.g., “0”=left LED, “1”=right LED). If using a “center” code in a tri-LED configuration, then two-bits may be utilized to create, for example, “00”=left LED, “01”=right LED, and “10”=center LED. Other and/or alternative information may be included in each message.

Each of the IR transmitters may have physical switch settings (e.g., dip switches) that provides for setting different modes of operation. TABLE I shows operating modes and associated switch settings of switches 4-7. Because there are four switch settings, up to 16 different modes may be provided (e.g., tri-LED mode, left/right/center mode, etc.). Dual LED mode may provide for left and right LEDs that output the same data (e.g., IR tag identifier) as opposed to dual mode with left/right codes, which provides for some of the same data (e.g., IR tag identifier) and different data (e.g., “left” and “right” codes) to be output by each of the left and right LEDs.

TABLE I

| Mode | SW4 | SW5 | SW6 | SW7 |
|---|---|---|---|---|
| Single LED Mode | Off | On | On | On |
| Dual LED Mode | On | Off | Off | On |
| Left/Right Mode | On | Off | Off | Off |

TABLE II shows switch settings for adjusting communication range of an IR transmitter, which is based on power applied to each LED, by setting switches 1 and 2. Each of the ranges may be set based on different distances that the IR transmitters have to communicate. For example, since an IR transmitter that is positioned in a grocery store aisle may have a maximum of three feet to communicate, where three feet represents approximately half of an aisle since a shopping cart will typically be positioned within that distance as it travels along the aisle, the IR transmitter may be set to a low range. However, where an IR transmitter is positioned in a wander area of a retail store, such as in a produce section within a grocery store, shopping carts may travel at longer distances from the IR transmitter such that the IR transmitter may be set to a high range. The switch settings for power may be set as the IR transmitters are being installed or preset by a manufacturer or network operator and labeled as “Low,” “Low-Medium Range,” “Medium-High Range,” and “High Range,” so that people installing the IR transmitters in the retail store may select the proper IR transmitter without having to make any in-store switch adjustments. Alternatively, rather than using relative range markings, estimated actual distances (e.g., “3 feet,” “6 feet,” “9 feet,” “15 feet”) that each of the settings may produce may be used to label the IR transmitters.

TABLE II

| Range | SW1 | SW2 |
|---|---|---|
| High Range | On | On |
| Medium-High Range | On | Off |
| Low-Medium Range | Off | On |
| Low Range | Off | Off |

TABLE III shows an illustrative data packet format, where each data packet is sent out in the format inclusive of each of the 12-bits. As shown, bits 11-9 are three bits to represent a battery voltage level, bit 8 represents left and right LED (e.g., “0” for left, “1” for right), and bits 7-0 represent IR tag code. By using an 8-bit IR tag code (bits 7-0), each store may have 256 IR tags without duplication, as described above. It should be understood that the use of more or fewer bits may provide for different numbers of IR tags within a retail store. It should also be understood that the data packet format may be different to provide for different or additional data. For example, rather than using three bits for battery voltage, thereby providing for seven different levels, two or one bit may be utilized, thereby providing for four levels (e.g., high, medium, low, replace battery) or two levels (e.g., power sufficient, replace battery), respectively. By changing the format, additional bits may be used for the IR tag code so as to provide for more than 256 IR tags within a single store.

TABLE III

| Bits 11-9 | Bit 8 | Bits 7-0 |
|---|---|---|
| Battery Voltage | Left/Right | IR Tag Code |

TABLE IV provides codes that may be associated with different battery voltage ranges. The different battery ranges are illustrative and may vary based on a battery voltage used for the IR transmitters or other factors.

TABLE IV

| | Voltage |
|---|---|
| Code | Range |
| 0 | <3.5 V-3.8 V |
| 1 | 3.9 V-4.1 V |
| 2 | 4.2 V-4.4 V |
| 3 | 4.5 V-4.7 V |
| 4 | 4.8 V-5 V |
| 5 | 5.1 V-5.4 V |
| 6 | 5.5 V-5.7 V |
| 7 | 5.7 V->6 V |

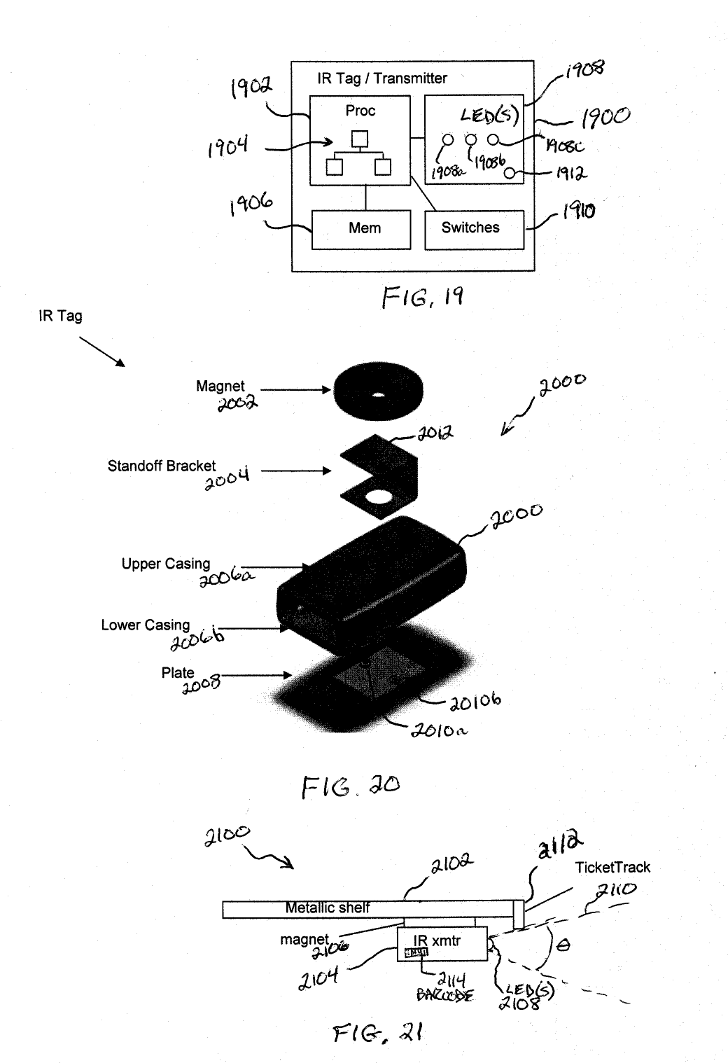

With regard to FIG. 19, an illustration of an illustrative IR tag or IR transmitter 1900 for use within a retail store is provided. The IR tag 1900 may include a processing unit 1902 that executes software 1904 for communicating IR tag signals that are used to identify the IR tag 1900, optionally left and right LEDs, and battery power is shown. In one embodiment, the processing unit 1902 may be an Amtel AVR microcontroller, such as an AVR ATmega88PA microcontroller. The processing unit 1902 may be configured with counters, timers, pulsewidth modulation functionality, and analog-to-digital converter circuitry. The processing unit 1902 may be in communication with a memory 1906, LED(s) 1908, and switches 1910. The memory 1906 may be utilized for storing data and software, as understood in the art. The LED(s) 1908 may be utilized to communicate IR signals with data, such as in the form of data packets, as previously described. The switches 1910 may be dip switches or other types of switches, and may be utilized to set various parameters, such as LED modes, power ranges, IR tag codes, and so forth. As an alternative to physical switches, memory elements that may be set by a computer in communication with the IR tag may be utilized to operate as logic switches. Although the processing unit 1902 is described as executing software 1904, it should be understood that the processing unit 1902 may be discrete logic that is hard-coded by the hardware itself.

In one embodiment, the processing unit 1902 may execute the software 1904 that may be configured to generate data packets. The data packets may include (i) IR tag numbers, as may be set by the switches 1910 or alternatively stored in the memory 1906 by a manufacturer or operator, (ii) LED identifiers (e.g., left or right), and (iii) battery voltage code, as previously described herein. As shown and described above, the IR tag may include one or more LEDs 1908 that are used to communicate IR signals that are identical or in-part different from one another. Using left, right, and center LEDs allows coverage area to be adjusted or functionality to be increased, as previously described.

In addition to the data communicating LED(s), one or more status indicator LED(s) 1912 may be utilized. The status indicator LED(s) 1912 may be red, green, or multi-color (e.g., red/green), as understood in the art. The status indicator LED(s) 1912 may be utilized to provide a visual indication of battery power and/or notification (e.g., flashing LED, color change) that battery power is low. Although not shown, driving electronics for driving the LEDs may be included as part of the processing unit 1902 or LED(s) 1908.

Voltage supply range may be between 3.7V and 6V in one embodiment. Having such a wide supply range maximizes battery usage. A battery voltage sensor circuit (not shown) may also be included in the IR tag 1900 to enable the processing unit 1902 to determine a code associated with the battery voltage as positioned in a set of battery voltage ranges, as provided in TABLE IV. A voltage regulator drive circuit (not shown) may be used to ensure that the IR LEDs are driven at a constant current regardless of the supply voltage, thereby providing a more consistent effective range for the transmitter. Analog-to-digital (A/D) and digital-to-analog (D/A) devices (not shown) may be utilized in conjunction with the LEDs, as understood in the art. In a multi-LED configuration, because the distance from the center LED 1908b to an IR receiver may be shorter than the distance from the left 1908a or right 1908c LEDs to the same IR receiver affixed to a shopping cart as the cart passes in front of the IR tag 1900 due to the left and right optical beams being directed at diagonal angles, power for driving the left 1908a and right 1908c LEDs may be regulated slightly higher than power to the center LED to account for the differences in distance.

With regard to FIG. 20, an illustration of an illustrative IR tag or IR transmitter 2000, which may include structural components for temporarily mounting the IR tag 2000 within a retail store, is shown. The IR tag 2000 may include a permanent magnet 2002, such as a ceramic magnet, that is adapted to be coupled to a standoff bracket 2004. Shelf price channels (i.e., a strip of metal generally called a ticket track that extends below a front edge of a shelf in a retail store to enable the retail store to post price tags) are generally an inch or so in height below the shelf. As such, the combination of the depths of the magnet 2002 and standoff bracket 2004 are to extend low enough to allow LEDs (not shown) of the IR tag 2000 to project below the shelf price channel and into a pathway when the IR tag 2000 is connected beneath a shelf via the magnet 2002 and facing outward toward a pathway in front of the shelf (see FIG. 4). The U-shaped standoff bracket 2004 is illustrative and alternative standoff bracket configurations may be utilized, including integrating the standoff feature into an upper casing 2006a of the IR transmitter 2000. A lower casing 2006b may be fastened to the upper casing 2006a (collectively a casing 2006) using fasteners, such as screws, bolts, adhesives, or other fastening members. Alternatively, rather than using fasteners, the casings may be configured to engage one another such that fastening members may be eliminated, thereby reducing cost and manufacturing time.

Electronic boards (not shown) that include electronics provided in FIG. 19 may be disposed between and mounted to one or both of the upper and lower casings 2006a and 2006b. A plate 2008, which is shown below the lower casing, may be positioned within the casings 2006a and 2006b or mounted to the upper casing 2006a. The plate 2008 is shown to include bolt receivers 2010a and 2010b that are connected to the plate 2008, thereby enabling bolts to extend through the standoff bracket 2004, upper casing 2006a, and bolt receivers 2010a and 2010b to secure the standoff bracket 2004 to the upper casing 2006a. The magnet 2002 may be secured to the standoff bracket 2004 using a fastener (not shown), such as a bolt and nut, that extends through the center of the magnet 2002 and into an opening 2012 of the standoff bracket 2004. Alternative configurations of the magnet 2002, standoff bracket 2004, and casing 2006 may be utilized to provide for the same or analogous functionality.

With regard to FIG. 21, an illustrative IR transmitter/shelf configuration 2100 includes a metallic shelf 2102 with an IR tag or transmitter 2104 mounted below the metallic shelf 2102. To provide for a low cost and transportable (i.e., temporary installation with ease of removal) solution, rather than mounting the IR tag 2104 using permanent fixture components (e.g., nuts and bolts), a magnet 2106 may be connected to the IR tag 2104 so that the IR tag 2104 may be temporarily mounted to the metallic shelf using the magnet 2106. In the event that a shelf is not metallic, then Velcro® or other temporary affixing mechanism (e.g., double-sided tape or other adhesive) may be utilized. By using temporary fixture components, costs for installation of a cart tracking system may be significantly reduced as compared to a permanent installation. To install the IR tag 2104, an installer may simply affix the IR tag 2104 below the metallic shelf 2102 by contacting the magnet 2106 to the metallic shelf 2102. By installing the IR tag 2104 below the metallic shelf 2102, the device may be substantially out of store customers' field-of-view so as to avoid being aesthetically unpleasing to customers of the retail store. As shown, LED(s) 2108 may create one or more beam(s) 2110 of IR light that has an angle θ both in the elevation and azimuth directions. As shown the IR light beam(s) 2110, which may be invisible to the human eye, may pass below a ticket track 2112 as a result of the magnet 2106, standoff (not shown), and casing of the IR transmitter 2104 causing the LED(s) to be extended below the ticket track 2112. To simplify installation, the IR transmitter 2104 may include a barcode 2114 or other indicia (e.g., QR code) affixed thereto, as further described with regard to FIG. 27 below. It should be understood that the term “scan” or “scanner” may include traditional barcode scanning as well as other types of indicia collection, such as taking an image, such as a photographic image, of an indicia, such as a QR code, and reading the indicia to determine content being represented by the indicia.

With regard to FIG. 27, a flow diagram of a process 2700 for enabling a person to install the IR transmitter 2104 (FIG. 21) is shown. The process 2700 starts at step 2702, a person installing the IR transmitter 2104 may use a barcode scanner to scan the barcode 2114 (FIG. 21) on the IR transmitter being installed. At step 2706, the person may scan another barcode located at a position at which the IR transmitter 2104 is being installed. In one embodiment, the barcode scanner is a Symbol Technologies barcode scanner with wired or wireless communications capabilities, and optionally configured to read a pair of barcodes and associate those barcodes for reporting. Alternatively, a computing device that receives the barcodes may associate the associated barcodes for creation of an IR transmitter and store position dataset. The barcode located at the position at which the IR transmitter is being installed may be a UPC barcode printed on a product. At step 2706, the transmitter and location information represented by the barcodes may be collected.

At step 2708, data based on the position data of the transmitters may be generated. As an example, the data may include number of shopping carts that pass by a specific product and length of time that each shopping cart spent in front of a specific product. By enabling the installer to scan the barcode 2114 of the IR transmitter 2104 and a product, installation of the IR transmitter and creating a data record of the locations of the transmitter 2104 is simplified. In other words, by simply scanning an indicia associated with the IR transmitter 2104 and barcode associated with a particular location (e.g., product UPC code) at which the IR transmitter 2104 is being positioned, a system that processes shopping cart tracking data may use the information collected as the devices are being installed without further human intervention. At step 2710, a report of the data may be presented to a user. The data may be a list of IR transmitters including the IR transmitter 2104 along with an associated position (e.g., product name, aisle, and/or X-Y-Z coordinates) in the retail store.

In one embodiment, the computing device may additionally store data representative of a map, such as a planogram maintained by the retail store or network service provider, that lists specific shelving configurations and specific locations on the shelves at which the products are located. The IR transmitters may therefore be associated with specific locations on the map, which may provide for actual and/or relative positioning of the IR transmitters. In one embodiment, to ensure location accuracy, the IR transmitters may be positioned using a certain placement, such as in alignment with a left, right, or center of a product display, if scanning a product UPC barcode to identify location. The specific locations may enable shopping cart tracking data, such as number of shopping carts that pass through a zone of a pathway, to be generated as a function of the specific locations of the IR transmitters. Reporting of the data may include statistics of the shopping cart tracking data, such as time through particular zones or entire store. The shopping cart tracking data may also be integrated with other shopping cart tracking data and be considered to be reported as part of broader statistics. It should be understood that as an alternative to scanning barcodes, the installer may enter identifiers into a graphical user interface to collect the information that may be used to determine location information of the IR transmitter 2104.

While some applications of the IR transmitters may utilize specific dimensional locations of the IR transmitters, other applications may utilize the fact that the IR transmitters are positioned in front of a certain product, such as a particular brand of soft drink (e.g., tracking how long a shopper is in front of the soft drink). It should be understood that this same location determination process may be utilized for installing other electronic or non-electronic equipment on shelves or other fixtures in the retail store.

With regard to FIG. 22, a block diagram of an illustrative IR receiver 2200 that may receive signals from IR tags throughout a retail store is shown. The IR receiver 2200 may include a processing unit 2202 that executes software 2204. The processing unit 2202 may be configured to receive communications from IR tags, such as the IR tag of FIG. 19, via an IR sensor 2206, and store data received from the communications in a memory 2208. The communications may be in the form of a data packet that includes IR tag identifier or number (bits 0-7), left/right bit code (bit 8), battery level code (bits 9-11), and/or other data, as previously described. The processing unit 2202 may further be in communication with a clock 2210 or configured with an onboard clock (not shown) to generate and associate a timestamp with each communication received from an IR tag. The timestamp may be a relative timestamp to provide for time between receipts of IR tag communications or a real-time timestamp that identifies actual date/time.

The processing unit 2202 may further be in communication with the memory 2208 that is configured to store received data from IR tags, IR sensor 2206 that is configured to receive IR communications from the IR tags, and I/O unit 2212 that enables the IR receiver 2200 to communicate IR tag data to a computing system either local to (e.g., personal computer connected to or in the local vicinity of the IR receiver 2200) or remote from (e.g., server located in a remote location of the retail store) the IR receiver (see, for example, FIG. 5). The I/O unit 2212 may include a hard-wire data port or wireless data port for enabling the IR receiver 2200 to upload and download data, such as the IR tag data. The software 2202 may be configured to store the IR tag data along with respective timestamps for a periodic time duration (e.g., weekly) or until an event occurs (e.g., passes an IR tag at a checkout counter). In the event triggered upload configuration, then in response to an event occurring (e.g., receiving an IR tag signal at the checkout counter), then the processing unit may cause the IR tag data along with the timestamps from the shopping trip to be communicated to a server within or remotely located from the retail store. In an alternative configuration, rather than storing multiple IR tag data, the IR receiver may communicate each IR tag data as it is received to a server that is collecting the cart tracking data. In such an alternative configuration, the server that receives the IR tag data may create the timestamp as opposed to the IR receiver 2200.

Analog-to-digital (A/D) and digital-to-analog (D/A) devices (not shown) may be utilized in conjunction with the IR sensor 2206. In one embodiment, the IR receiver 2200 is a “dummy” receiver in that it merely collects data, and a computing system that collects IR tag data from the IR receiver processes the data. Alternatively, the IR receiver 2200 may process the collected IR tag data to determine shopping cart path, zones, velocity, etc., or some portion thereof.

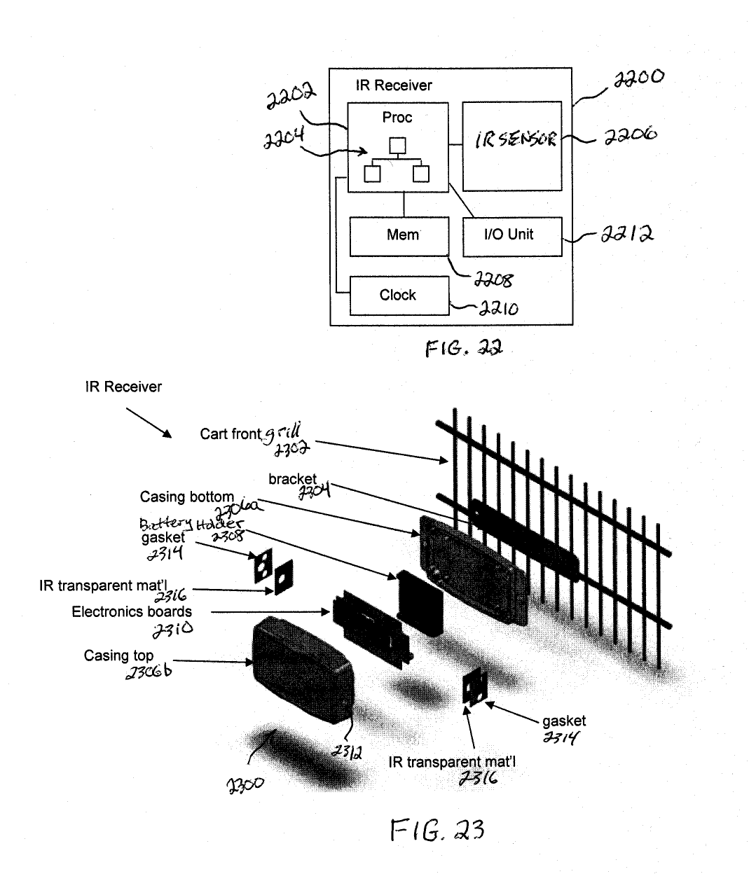

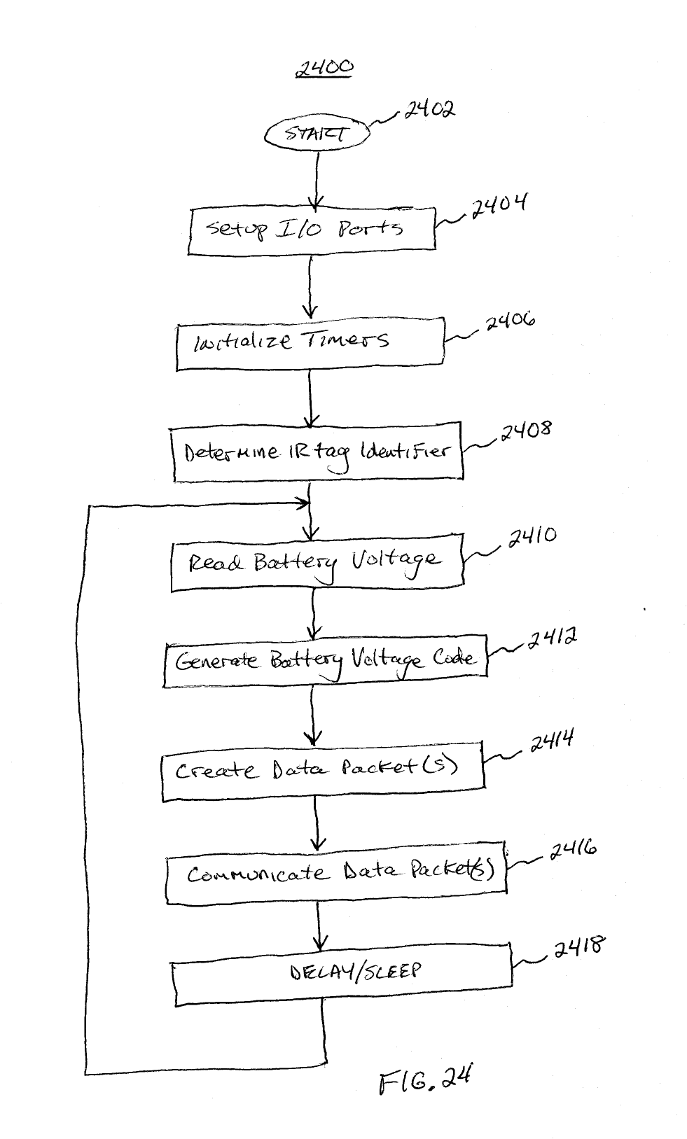

With regard to FIG. 23, an illustration of an exploded view of an illustrative IR receiver 2300 that is mounted to a front grill 2302 of a cart is shown. A bracket 2304 is mounted to the front grill 2302 of a shopping cart. Although the bracket 2304 is shown to be on the front-side of the front grill 2302, the bracket may alternatively be mounted to the back-side of the front grill 2302 or anywhere else on the shopping cart. A casing bottom 2306a may be connected to the bracket 2304. A battery holder 2308 that is configured to hold batteries, such as AA batteries, to power the IR receiver 2300 may be adapted to be positioned within the casing bottom 2306a. One or more circuit boards 2310 may be included and mounted to standoffs (not shown), which may be formed on or mounted to the casing bottom 2306a. The circuit boards 2310 may include the electronic components of FIG. 22. A casing top 2306b, which when combined with the casing bottom 2306a, may form a casing 2306 of the IR receiver 2300. The casing top 2306b may include IR sensor openings 2312 on one or more sides to enable IR sensors to receive IR signals from IR tags disposed throughout a retail store. In addition, in the case of using hardwired communications for uploading the collected IR tag data, the casing top 2306b may include a communications port opening (not shown) through which a communications port, such as a USB port, may enable a user to access data collected by the IR receiver 2300.

Because the IR receiver 2300 will be brought into various weather conditions, such as rain and snow, gaskets 2314 may be placed at each of the IR sensor openings and an IR transparent material (e.g., red plastic material) 2316 may be positioned between the gasket 2314 and IR sensor opening 2312 such that the IR sensor in combination with the gasket 2314 can receive IR signals, but prevent water from entering the casing 2306. By including IR sensors on both sides of the IR receiver 2300, the IR receiver 2300 may detect IR signals from IR tags from either side of an aisle while traveling in either direction. It should be understood that an IR sensor opening may also be included on the top and bottom of the casing top 2306b to enable IR tags to be positioned above and below the pathways in the retail store, as well.

The IR receiver 2300 may be positioned on the front grill 2302 of the shopping cart in a position such that when the cart is inserted into the rear of another cart, generally known as being “nested,” the IR receiver 2300 does not contact the rear of the other cart. As understood in the art, the rear of carts and front grill of carts are angled such that the top front edge of a cart contacts the rear of a cart, while the remainder of the front grill does not contact the rear of the other cart. By positioning the IR receiver below a certain distance from the top of the front grill 2302, the IR receiver 2300 may avoid contacting other carts when nested, thereby reducing chance of damage to the IR receiver 2300. It should be understood that different carts have different configurations such that the distance below the top may vary from cart type to cart type. It should also be understood that the IR receiver 2300 may be mounted on alternative locations of the cart and still operate as described herein. In addition to mounting locations, the casing of the IR transceiver 2300 may be thin enough (e.g., maximum of 2-inches deep) such that the casing does not extend beyond a distance that would otherwise allow the IR receiver 2300 to contact a rear end of another cart to which the cart is being nested. The casing may be formed of high-strength plastic or other material to protect the electronics.

With regard to FIG. 24, a flow diagram of an illustrative process 2400 for an IR tag to perform cart tracking communications is shown. The process 2400 may start at step 2402. The process 2400 may initially reset the IR tag by (i) setting up I/O ports at step 2404 to enable a processor to communicate with LEDs for communication of data signals, and initializing timers at step 2406, where the timers may set-up data communications speed, pulsewidth modulation of data signals, burst modes of data, delays, and other timers. At step 2408, an IR tag identifier may be determined. In one embodiment, the IR tag identifier may be determined by reading settings of switches. Alternatively, the IR tag identifier may be determined by reading a memory location.

At step 2410, battery voltage may be read. From the battery voltage, a battery voltage code associated with battery voltage may be generated at step 2412, where the battery voltage code may be the same or analogous to those provided in TABLE IV. At step 2414, one or more data packets may be created. In creating the data packets, IR tag identifier, battery voltage code, and optionally left/right/center code may be included in the data packet(s). The data packet(s) may also include a preamble. A postamble may optionally included in the data packet(s), as well. At step 2416, the data packet(s) may be communicated via an LED or other illumination device. In communicating the data packet(s), the data packet(s) may be communicated more than once, such as three times. If the IR tag includes left and right LEDs, then the data packet may be communicated by the left LED first and then the second LED second, where the data packets communicated by the left LED and right LED may be the same or distinguished by a “left” and “right” bits, as previously described. In an alternative embodiment, the left and right LEDs may be communicated simultaneously. If the IR tag includes three LEDs, then the left, right, and center may be used to communicate in a sequence or simultaneously.

At step 2418, after the data packet(s) are communicated, a delay or sleep may occur. The delay or sleep may be used to reduce battery power usage. The delay may be one second long or otherwise. However, the delay should be set such that each IR receiver that is pushed past an IR tag receives a communication from the IR tag. In one embodiment, an IR tag synchronization process may occur, where an in-store global “beacon” or one or more IR tags may operate as “beacons” to which slave IR tags may synchronize, thereby causing each IR tag to communicate at approximately the same time (e.g., within a few milliseconds of one another).

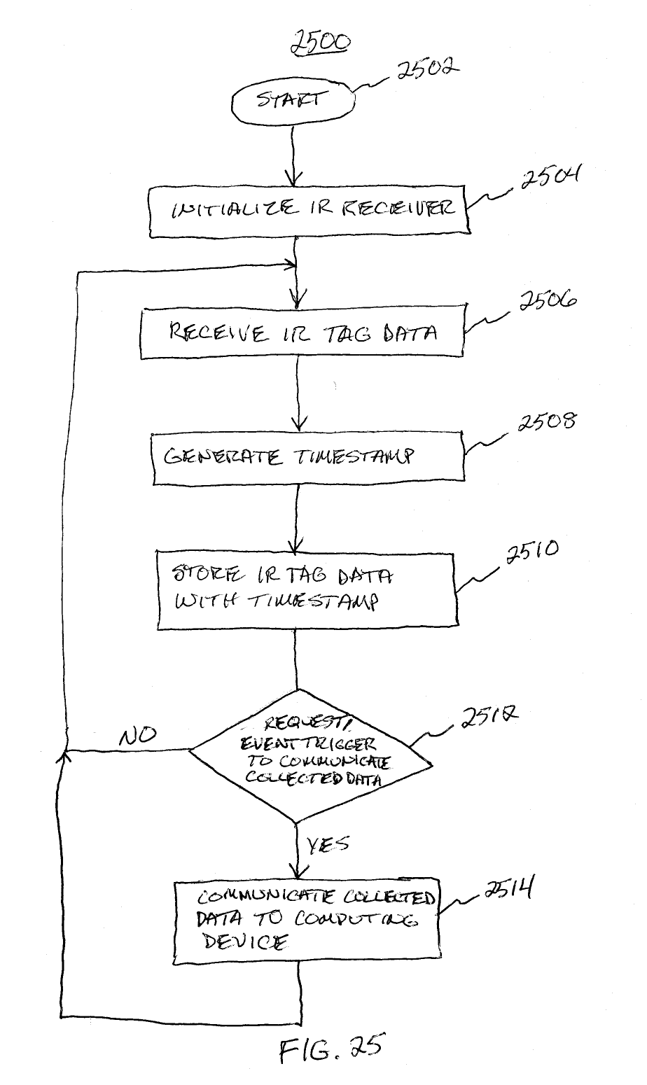

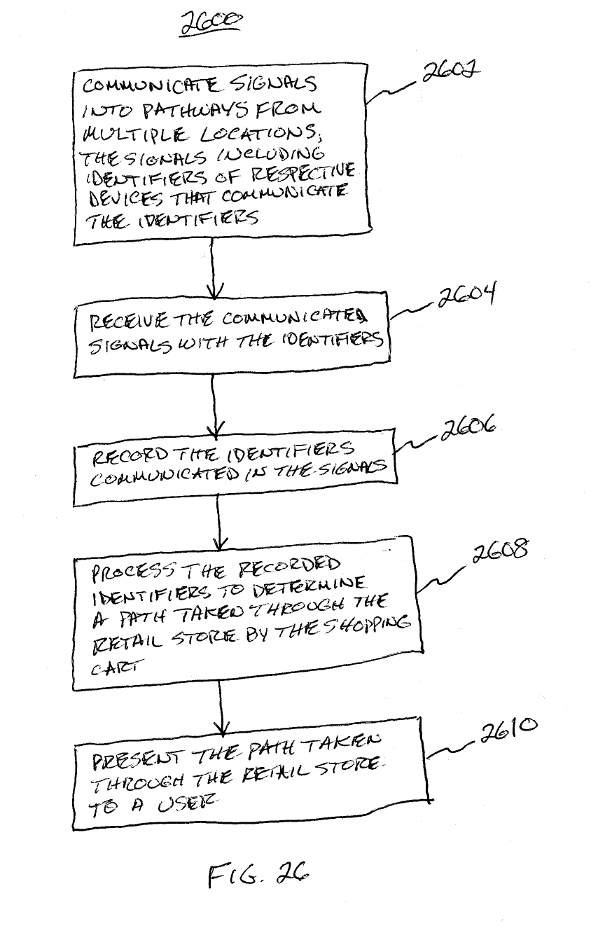

With regard to FIG. 25, a flow diagram of an illustrative process 2500 for an IR receiver to operate is shown. The process starts at step 2502. At step 2504, the IR receiver may be initialized. In initializing the IR receiver, memory may be cleared, timers reset, and clock synchronized. In one embodiment, the clock may be a real-time clock that includes time and optionally date or the clock may be a relative clock that is utilized to determine differences in times when the IR receiver passes IR tags. At step 2506, IR tag data may be received. The IR tag data may include (i) an IR tag identifier, (ii) left, right, or center indicator, and battery level code. As previously described, different or additional information may also be included in the IR tag data. At step 2508, in response to receiving the IR tag data, a timestamp may be generated and associated with the IR tag data. At step 2510, IR tag data may be stored with the timestamp. The process 2500 loops back to step 2506 to continue receiving IR tag data. If the IR tags are synchronized, then the IR receiver may “sleep” for approximately the same time period (e.g., one second) since no IR tag data is transmitted during the “sleep” period. By synchronizing the IR tags, battery life of the IR receiver may be preserved. In one embodiment, the IR receiver is synchronized in the same manner as the IR tags (i.e., being synchronized by a “beacon”). Alternatively, the IR receiver may receive an IR tag signal and synchronize from that signal (i.e., receive signal, sleep, receive signal, sleep, etc.).

At step 2512, a determination may be made as to whether a request or event trigger to communicate the collected data is made. If either a request or event trigger occurs, then at step 2514, the stored or collected IR tag data and timestamp may be communicated or uploaded to a computing device. A request may be made by a user connecting a computer to the IR receiver either via a physical wire or via a wireless connection (e.g., using Bluetooth or other communications protocol). In one embodiment, an event trigger for communication of the IR tag data and timestamps may be a periodic upload event trigger, where the periodic upload event trigger may be set as daily or weekly on a receiving device or at a computing device that sends wireless requests to the IR receiver. Still yet, the event trigger may be a determination that the memory is full. Any other event trigger may be utilized to cause the IR tag data and timestamps to be uploaded, such as in response to receiving IR tag data at a checkout line, which, in effect, causes the IR receiver to upload data after each shopping trip. If, at step 2514, no request or event trigger occurs, then the process repeats the process back at step 2506.

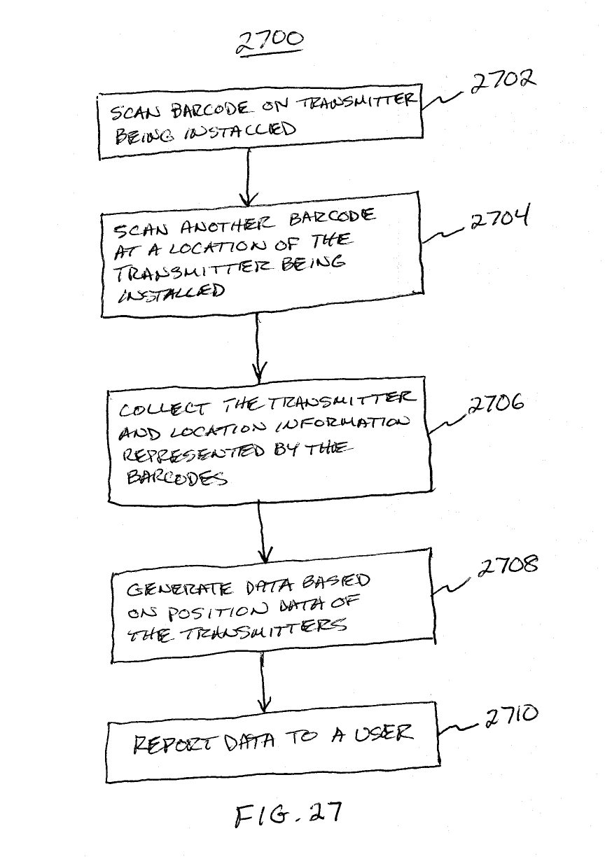

With regard to FIG. 26, an illustrative process 2600 for tracking a shopping cart through pathways in a retail store is shown. The process starts at step 2602, where signals are communicated into the pathways from multiple locations. The signals may include identifiers of respective devices that communicate the signals. In one embodiment, the signals are IR signals. At step 2604, a receiver on the shopping cart may receive the communicated signals with the identifiers. The identifiers communicated in the signals may be recorded. In one embodiment, the identifiers, which are considered to also represent location within the retail store, may be recorded in the device in a list with other identifiers received. The recorded identifiers may be processed to determine a path taken by the shopping cart through the retail store. In processing the recorded identifiers, additional data, such as actual locations in the retail store or relative positions with respect to other transmitters, may be utilized to generate position, speed, direction, and other cart travel information. The path of the shopping cart taken through the retail store may be presented to a user. In one embodiment, the presentation may include the path taken during a single shopping trip. Alternatively, the presentation may include the shopping path in an accumulation of multiple other shopping trips. In other words, the presentation may be part of a larger presentation that shows average shopping trips or percentages from shopping trips, for example.

Although the principles of the present invention have been described as mounting IR tags to fixtures of the retail store, it should be understood that a reverse configuration may be utilized, where an IR tag is affixed to the shopping carts and IR receivers are affixed to the retail shelves. Such a configuration, however, may result in higher costs due to having more receivers, more complex communications, and less efficient battery usage. In yet an alternative embodiment, rather than using an optical configuration, low power level RF communications, including the use of active or passive RFID devices, may be utilized. In one embodiment, the active or passive RFID tags may substitute the IR tags positioned along the pathways, as described hereinabove. However, such a configuration may be more costly and difficult to implement due to the inherent nature of RF interacting in electromagnetic noisy environments due to large amounts of metal in retail stores.

While description describes the principles of the present invention as being primarily utilized within retail stores, it should be understood that the principles of the present invention may be used with retail environments. Retail environments may include shopping malls, airports, stadiums, arenas, museums, department stores, drug stores, and any other place where people aggregate.

It should further be understood that in addition to the retail environments, that people in non-retail environments may be tracked. As an example, tracking specific vehicles throughout a roadway multiple roadways may be tracked and zones may be established to determine placement of signs, electronic and/or non-electronic, and audience delivery for content displayed on the signs. By tracking specific vehicles rather than total vehicle count without identifying particular vehicles, media metrics may be better determined. For example, by knowing specific vehicles that travel a certain stretch of highway, a determination may be made as to how many of the same people had the opportunity to view a single advertisement a certain number of times. In tracking the specific vehicles, toll-tags of the vehicles, other electronic devices that may be installed in the vehicles, license plates, or other identifying means may be monitored and tracked. If, for example, license plates are used, imaging software may be utilized to perform identification of the license plate number. Software executed on a computing system may track zones in which the vehicles travel on the roadway.

In addition, the principles of the present invention allow customer or shopper data to be collected using non-shopping cart and non-basket techniques. Such techniques may provide for tags or sensors to be carried or worn by a user (e.g., hand-held device or badge attached to clothing) to track the person with the tags or sensors as the customers travel throughout the retail environment.

The previous detailed description of a small number of embodiments for implementing the invention is not intended to be limiting in scope. One of skill in this art will immediately envisage the methods and variations used to implement this invention in other areas than those described in detail.

What is claimed:

1. A system for tracking a shopping cart in a retail store, said system comprising:
a plurality of transmitter devices positioned along pathways within the retail store and being configured to communicate respective signals into the pathways, the signals including identifiers to identify respective transmitter devices from which the signals are being communicated;
a receiver device connected to a shopping cart, and configured to receive and record the identifiers communicated in the signals; and
a computer system configured to:
receive the recorded identifiers from said receiver device;
process the recorded identifiers to determine a path taken by the shopping cart through the retail store; and
present the path of the shopping cart taken through the retail store to a user.

2. The system according to claim 1, wherein said receiver device is further configured to:
generate a timestamp in response to receiving a signal with an identifier from a transmitter device;
store the timestamp in association with the identifier in the recorded data; and
wherein said computer system is further configured to:
determine an amount of time for the shopping cart to traverse throughout the retail store; and
present time for the shopping cart to traverse throughout the retail store to the user.

3. The system according to claim 2, wherein the timestamp includes a time of day.

4. The system according to claim 1, wherein said transmitter devices are configured to transmit IR signals.

5. The system according to claim 1, wherein said transmitter devices are configured to transmit a plurality of signals that are spatially separated within the pathways, and wherein said receiver device is configured to sense each of the signals and record data communicated in the signals, thereby providing for direction of travel of the shopping cart in the pathways.

6. The system according to claim 5, wherein each of the spatially separate signals have a different code contained therein that is indicative of left and right sides of a transmitter device that generated the signals.

7. The system according to claim 1, wherein said receiver device is connected to a front member of the shopping cart.

8. The system according to claim 1, wherein said receiver device includes a housing that encloses electronics, and wherein the housing includes openings on left and right sides for receiving elements to be positioned.

9. The system according to claim 1, wherein said transmitter devices include a magnet to enable said transmitter devices to be temporarily secured to metallic shelves in the retail store.

10. The system according to claim 1, wherein the signals further include a battery voltage level code representative of a battery voltage of a battery being used to power respective transmitter devices.

11. The system according to claim 10, wherein the voltage level code is indicative of the battery voltage level being within one of a plurality of voltage ranges.

12. The system according to claim 1, wherein said transmitter devices are further configured to burst the signals in sets of three successive times with a time gap between the successive sets of bursts.

13. The system according to claim 1, wherein said computer system is further configured to determine a length of time that the shopping cart is positioned in front of a specific product.

14. A method for tracking a shopping cart through pathways in a retail store, said system comprising:
communicating signals into the pathways from multiple locations, the signals including identifiers of respective devices that communicate the signals;
receiving the communicated signals with the identifiers by a receiver on the shopping cart;
recording the identifiers communicated in the signals;
processing the recorded identifiers to determine a path taken by the shopping cart through the retail store; and
presenting the path of the shopping cart taken through the retail store to a user.

15. The method according to claim 14, further comprising:
generating a timestamp in response to receiving a signal with an identifier;
storing the timestamp in association with the identifier;
determining an amount of time for the shopping cart to traverse throughout the retail store; and
presenting an amount of time for the shopping cart to traverse throughout the retail store to the user.

16. The method according to claim 15, wherein generating the timestamp includes generating a time of day.

17. The method according to claim 15, wherein communicating signals includes communicating IR signals.

18. The method according to claim 14, wherein communicating the signals includes communicating signals that are spatially separated within the pathways, and wherein receiving the signals includes sensing each of the signals and recording data communicated in the signals, thereby providing for direction of travel of the shopping cart in the pathways.

19. The method according to claim 18, wherein communicating the spatially separate signals includes communicating signals having different codes contained therein that are indicative of relative spatial separation of the spatially separate signals.

20. The method according to claim 14, further comprising receiving the signals at a front location of the shopping cart.

21. The method according to claim 14, wherein receiving the signals includes receiving the signals from either or both sides of the pathways.

22. The method according to claim 14, further comprising temporarily securing a transmitter device to metallic shelves in the retail store, the transmitter device being configured to communicate the signals.

23. The method according to claim 14, wherein communicating the signals includes communicating a battery voltage level code of a battery level of a battery being used to power respective transmitter devices being used to communicate the respective signals.

24. The method according to claim 23, wherein generating the battery voltage level code includes generating a battery voltage level code that is indicative of the battery voltage level being within one of a plurality of voltage ranges.

25. The method according to claim 14, wherein communicating the signals includes communicating the signals in sets of three successive times, and including a time gap during which no data is communicated between the successive sets of communicated signals.

26. The system according to claim 14, further comprising determining a length of time that the shopping cart is positioned in front of a specific product.

27. A method for determining placement of an electronic device in a retail store, said method comprising:
scanning an indicia on the electronic device being installed in a retail store;
scanning another indicia at a location in the retail store at which the transmitter is being installed;
collecting the transmitter and location information represented by the barcodes;
generating data based on position data of the transmitter; and
reporting the data to a user.

28. The method according to claim 27, wherein the electronic device is a transmitter device.

29. The method according to claim 27, wherein the indicia on the electronic device is a barcode, and wherein the indicia at the location of the transmitter being installed is a UPC barcode on a product at the location.

30. The method according to claim 27, wherein generating data includes generating shopping cart tracking data, and wherein reporting the data includes reporting statistics of the shopping cart tracking data.
